(19) United States
(12) Patent Application Publication
(10) Pub. No.: US 2014/0323300 A1
(43) Pub. Date: Oct. 30, 2014

(54) HERBICIDAL COMPOUNDS

(71) Applicant: SYNGENTA LIMITED, Guildford (GB)

(72) Inventors: William Guy Whittingham, Bracknell (GB); Nicholas Phillip Mulholland, Bracknell (GB); Russell Viner, Bracknell (GB); Alison Clare Elliott, Bracknell (GB); Katy Louise Bridgwood, Bracknell (GB); John Martin Clough, Bracknell (GB); Kevin Beautement, Bracknell (GB); Glynn Mitchell, Bracknell (GB); Gordon Munns, Bracknell (GB)

(73) Assignee: SYNGENTA LIMITED, Guildford (GB)

(21) Appl. No.: 14/364,038

(22) PCT Filed: Dec. 7, 2012
(86) PCT No.: PCT/EP2012/074781

§ 371 Date: Jun. 9, 2014

(30) Foreign Application Priority Data
Dec. 9, 2011 (GB) 1121317.0

(51) Int. Cl. A01N 43/58; A01N 43/84; A01N 43/80; A01N 43/90

(52) U.S. Cl. CPC A01N 43/58; A01N 43/90; A01N 43/84; A01N 43/80
USPC 504/103; 544/238; 504/238; 504/237; 544/114; 504/225

(57) ABSTRACT

The present invention relates to compounds of Formula (I), or an agronomically acceptable salt of said compounds wherein R¹, R², R³ and R⁴ are as defined herein. The invention further relates to herbicidal compositions which comprise a compound of Formula (I), and to their use for controlling weeds, in particular in crops of useful plants.

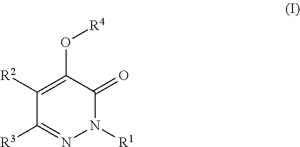

The present invention relates to novel pyridazinone derivatives, to processes for their preparation, to herbicidal compositions which comprise the novel derivatives, and to their use for controlling weeds, in particular in crops of useful plants, or for inhibiting plant growth.

Thus, according to the present invention there is provided a compound of Formula (I):

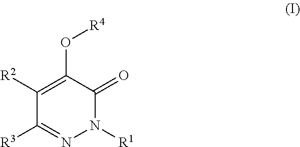

or an agronomically acceptable salt thereof,
wherein:—
R¹ is selected from the group consisting of A1 and A2

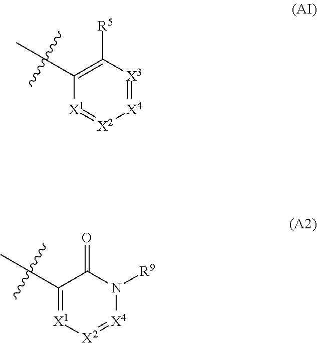

wherein
X¹ is N or CR⁷;
X² is N or CR⁸;
X³ is N or CR⁹;
X⁴ is N or CR⁶;
R² is selected from the group consisting of hydrogen, halogen, cyano, C₁-C₆alkyl, C₃-C₆cycloalkyl, C₂-C₆alkenyl, C₄-C₆cycloalkenyl, C₂-C₆alkynyl, C₁-C₆haloalkyl, C₁-C₆ alkoxy, C₁-C₆alkoxy-C₁-C₃-alkyl, C₁-C₆ alkoxy-C₂-C₆alkoxy-, C₁-C₆ alkoxy-C₂-C₆alkoxy-C₁-C₃alkyl-, C₃-C₆cycloalkylC₁-C₃-alkyl-, amino, C₁-C₆alkylamino, C₁-C₆dialkylamino, C₁-C₃ alkylcarbonylaminoC₁-C₄alkyl-, C₁-C₆alkyl-S(O)p-, C₁-C₆alkyl-S(O)p-C₁-C₃-alkyl, C₁-C₆haloalkyl-S(O)p- and C₁-C₆haloalkyl-S(O)p-C₁-C₃-alkyl;
R³ is selected from the group consisting of hydrogen, hydroxyl, halo, nitro, amino, cyano, C₁-C₆alkyl, C₁-C₃alkoxy, C₃-C₆cycloalkyl, C₂-C₆alkenyl, C₂-C₆alkynyl, C₁-C₆haloalkyl, C₁-C₆alkoxy-C₁-C₃-alkyl, C₃-C₆cycloalkyl-C₁-C₃-alkyl, C₁-C₆alkyl-S(O)p-, C₁-C₆alkyl-S(O)ₚ—C₁-C₃-alkyl, C₁-C₆haloalkyl-S(O)ₚ—, C₁-C₃alkylamino, C₁-C₃dialkylamino and C₁-C₆haloalkyl-S(O)ₚ—C₁-C₃-alkyl;
R⁴ is selected from the group selected from hydrogen, C₁-C₆alkylcarbonyl, arylcarbonyl, C₁-C₆alkoxycarbonyl, C₁-C₆alkyl-S(O)ₚ—, C₁-C₆alkyl-S(O)ₚcarbonyl- and aryl-S(O)p-, wherein said aryl groups may be optionally substituted by one or more R¹¹;
R⁵ is selected from the group consisting of hydroxyl, halogen, C₁-C₆alkyl, C₁-C₆cycloalkyl, C₁-C₆haloalkyl, C₂-C₆alkenyl, C₂-C₆haloalkenyl, C₂-C₆alkynyl, C₁-C₆ alkoxy, C₂-C₆ alkenyloxy-, C₃-C₆cycloalkylC₁-C₃-alkyl-, C₁-C₆ alkoxyC₁-C₃alkyl, C₁-C₆ alkoxy-C₂-C₆alkoxy, C₁-C₆ alkoxy-C₂-C₆alkoxy-C₁-C₃alkyl, C₁-C₆ haloalkoxy, C₁-C₆ haloalkoxy-C₁-C₃alkyl, C₁-C₆alkyl-S(O)p-, C₁-C₆haloalkyl-S(O)p-, aryl, aryl-S(O)p, heterocyclyl, heterocyclyl-S(O)p, aryloxy, aryl-C₂-C₆alkyl-, aryl-C₁-C₆alkoxy-, heterocyclyloxy, heterocyclyl-C₁-C₃alkoxy-C₁-C₃alkyl, hydroxycarbonyl, hydroxycarbonyl-C₁-C₃ alkoxy-, C₁-C₃ alkoxycarbonyl, C₁-C₃ alkoxycarbonyl-C₁-C₃ alkoxy-, C₁-C₃alkylamino-, C₁-C₃dialkylamino-, C₁-C₃ alkylamino-S(O)p-, C₁-C₃ alkylamino-S(O)p-C₁-C₃alkyl-, C₁-C₃ dialkylamino-S(O)p-, C₁-C₃ dialkylamino-S(O)p-C₁-C₃alkyl-, C₁-C₃alkylaminocarbonyl-, C₁-C₃alkylaminocarbonyl-C₁-C₃alkyl-, C₁-C₃dialkylaminocarbonyl-, C₁-C₃ dialkylaminocarbonyl-C₁-C₃alkyl-, C₁-C₃alkylcarbonylamino-, C₁-C₃ alkyl-S(O)p-amino-, C₁-C₃alkyl-S(O)p-C₁-C₃alkylamino-, C₁-C₃alkyl-S(O)p-aminoC₁-C₃alkyl-, cyano and nitro, wherein said heterocyclyls are five or six membered heterocyclyls containing from one to three heteroatoms each independently selected from the group consisting of oxygen, nitrogen and sulphur, and wherein the aryl or heterocyclyl components may be optionally substituted by one or more substituents selected from the group consisting of halo, C₁-C₃alkyl, C₁-C₃haloalkyl, C₁-C₃ alkoxy, C₁-C₃ haloalkoxy, phenyl, cyano and nitro;
R⁶ and R⁹ are independently selected from the group consisting of hydrogen, hydroxyl, halogen, C₁-C₆alkyl, C₁-C₆cycloalkyl, C₁-C₆haloalkyl, C₂-C₆alkenyl, C₂-C₆haloalkenyl, C₂-C₆alkynyl, C₁-C₆ alkoxy-, C₂-C₆ alkenyloxy-, C₃-C₆cycloalkylC₁-C₃-alkyl-, C₁-C₆ alkoxyC₁-C₃alkyl-, C₁-C₆ alkoxy-C₂-C₆alkoxy-, C₁-C₆ alkoxy-C₂-C₆alkoxy-C₁-C₃alkyl-, C₁-C₆ haloalkoxy-, C₁-C₆ haloalkoxy-C₁-C₃alkyl-, C₁-C₆alkyl-S(O)ₚ—, C₁-C₆haloalkyl-S(O)ₚ—, aryl, aryl-S(O)ₚ—, heterocyclyl, heterocyclyl-S(O)ₚ—, aryloxy-, aryl-C₂-C₆alkyl-, aryl-C₁-C₆alkoxy-, heterocyclyloxy-, heterocyclyl-C₁-C₃alkoxy-C₁-C₃alkyl-, hydroxycarbonyl, hydroxycarbonyl-C₁-C₃alkoxy-, C₁-C₃ alkoxycarbonyl-, C₁-C₃alkoxycarbonyl-C₁-C₃ alkoxy-, C₁-C₃alkylamino-, C₁-C₃dialkylamino-, C₁-C₃alkylamino-S(O)ₚ—, C₁-C₃ alkylamino-S(O)ₚ—C₁-C₃alkyl-, C₁-C₃ dialkylamino-S(O)ₚ—, C₁-C₃ dialkylamino-S(O)ₚ—C₁-C₃alkyl-, C₁-C₃alkylaminocarbonyl-, C₁-C₃alkylaminocarbonyl-C₁-C₃alkyl-, C₁-C₃dialkylaminocarbonyl-, C₁-C₃ dialkylaminocarbonyl-C₁-C₃alkyl-, C₁-C₃alkylcarbonylamino-, C₁-C₃ alkyl-S(O)ₚ-amino-, C₁-C₃alkyl-S(O)ₚ—C₁-C₃alkylamino-, C₁-C₃alkyl-S(O)p-aminoC₁-C₃alkyl-, cyano and nitro, wherein said heterocyclyls are five or six membered heterocyclyls containing from one to three heteroatoms each independently selected from the group consisting of oxygen, nitrogen and sulphur, and wherein the aryl or heterocyclyl components may be optionally substituted by one or more substituents selected from the group consisting of halo, C₁-C₃alkyl, C₁-C₃haloalkyl, C₁-C₃ alkoxy, C₁-C₃ haloalkoxy, C₁-C₆alkyl-S(O)ₚ—, phenyl, cyano and nitro;
R⁷ is selected from the group consisting of hydrogen, halogen, C₁-C₃ alkyl-, C₁-C₃ alkoxy-, C₂-C₃alkenyl-, C₂-C₃alkynyl-, C₁-C₃ haloalkyl- and C₁-C₃haloalkoxy-;
R⁸ is hydrogen; or
R⁵ and R⁹ can together form a saturated or unsaturated 5- or 6-membered carbocyclic or heterocyclic ring, said heterocyclic ring comprising one or more nitrogen and/or oxygen heteroatoms, the 5- or 6-membered ring being optionally substituted by one or more R¹²; or
R⁶ and R⁹ can together form a saturated or unsaturated 5- or 6-membered carbocyclic or heterocyclic ring, said heterocyclic ring comprising one or more heteroatoms selected from the group consisting of nitrogen, oxygen and S(O)₂, the 5- or 6-membered ring being optionally substituted by one or more R¹²; or
R⁶ and R⁸ can together form an unsaturated 5- or 6-membered carbocyclic or heterocyclic ring, said heterocyclic ring comprising one or more nitrogen heteroatoms, the 5- or 6-membered ring being optionally substituted by one or more R¹³; and

R¹¹ is selected from the group consisting of halo-, C₁-C₃alkyl, C₁-C₃ haloalkyl and C₁-C₆alkoxy;
R¹² is selected from the group of hydrogen, cyano, halo-, oxy-, C₁-C₃alkylS(O)p-, C₁-C₃ alkyl, C₂-C₃alkenyl, C₂-C₃alkynyl, C₁-C₃ alkoxy and C₁-C₃ haloalkyl;
R¹³ is selected from the group of hydrogen, cyano, halo-, C₁-C₃alkylS(O)p-, C₁-C₃ alkyl, C₂-C₃alkenyl, C₂-C₃alkynyl, morpholinyl- and C₁-C₃ haloalkyl; and
p=0, 1 or 2.

Alkyl groups having a chain length of from 1 to 6 carbon atoms include, for example, methyl (Me, CH₃), ethyl (Et, C₂H₅), n-propyl, isopropyl (i-Pr), n-butyl (n-bu), iso-butyl (i-bu), sec-butyl and tert-butyl (t-butyl).

Alkenyl groups having a chain length of from 2 to 6 carbon atoms include, for example, —CH═CH₂ (vinyl) and —CH₂—CH═CH₂ (allyl).

Alkynyl groups having a chain length of from 2 to 6 carbon atoms include, for example, —C≡CH (ethynyl) and —CH₂—C≡CH (propargyl).

Cycloalkyl groups include c-propyl (c-Pr), c-butyl (c-Bu), c-pentyl and c-hexyl.

Halogen (or halo) encompasses fluorine, chlorine, bromine or iodine. The same correspondingly applies to halogen in the context of other definitions, such as haloalkyl or halophenyl.

Haloalkyl groups having a chain length of from 1 to 6 carbon atoms are, for example, fluoromethyl, difluoromethyl, trifluoromethyl, chloromethyl, dichloromethyl, trichloromethyl, 2,2,2-trifluoroethyl, 2-fluoroethyl, 2-chloroethyl, pentafluoroethyl, 1,1-difluoro-2,2,2-trichloroethyl, 2,2,3,3-tetrafluoroethyl and 2,2,2-trichloroethyl, heptafluoro-n-propyl and perfluoro-n-hexyl.

Suitable haloalkenyl radicals include alkenyl groups substituted one or more times by halogen, halogen being fluorine, chlorine, bromine or iodine and especially fluorine or chlorine, for example 2,2-difluoro-1-methylvinyl, 3-fluoropropenyl, 3-chloropropenyl, 3-bromopropenyl, 2,3,3-trifluoropropenyl, 2,3,3-trichloropropenyl and 4,4,4-trifluorobut-2-en-1-yl. Preferred C₂-C₆alkenyl radicals substituted once, twice or three times by halogen are those having a chain length of from 2 to 5 carbon atoms. Suitable haloalkylalkynyl radicals include, for example, alkylalkynyl groups substituted one or more times by halogen, halogen being bromine or iodine and, especially, fluorine or chlorine, for example 3-fluoropropynyl, 5-chloropent-2-yn-1-yl, 5-bromopent-2-yn-1-yl, 3,3,3-trifluoropropynyl and 4,4,4-trifluoro-but-2-yn-1-yl. Preferred alkylalkynyl groups substituted one or more times by halogen are those having a chain length of from 3 to 5 carbon atoms.

Alkoxy groups preferably have a chain length of from 1 to 6 carbon atoms. Alkoxy is, for example, methoxy, ethoxy, propoxy, isopropoxy, n-butoxy, isobutoxy, sec-butoxy or tert-butoxy or a pentyloxy or hexyloxy isomer, preferably methoxy and ethoxy. Alkylcarbonyl is preferably acetyl or propionyl. Alkoxycarbonyl is, for example, methoxycarbonyl, ethoxycarbonyl, propoxycarbonyl, isopropoxycarbonyl, n-butoxycarbonyl, isobutoxycarbonyl, sec-butoxycarbonyl or tert-butoxycarbonyl, preferably methoxycarbonyl, ethoxycarbonyl or tert-butoxycarbonyl. It should also be appreciated that two alkoxy substituents present on the same carbon atom may be joined to form a spiro group. Thus, the methyl groups present in two methoxy substituents may be joined to form a spiro 1,3 dioxolane substituent, for example. Such a possibility is within the scope of the present invention.

Haloalkoxy is, for example, fluoromethoxy, difluoromethoxy, trifluoromethoxy, 2,2,2-trifluoroethoxy, 1,1,2,2-tetrafluoroethoxy, 2-fluoroethoxy, 2-chloroethoxy, 2,2-difluoroethoxy or 2,2,2-trichloroethoxy, preferably difluoromethoxy, 2-chloroethoxy or trifluoromethoxy.

Alkylthio (alkyl-S—) groups preferably have a chain length of from 1 to 6 carbon atoms.

Alkylthio is, for example, methylthio, ethylthio, propylthio, isopropylthio, n-butylthio, isobutylthio, sec-butylthio or tert-butylthio, preferably methylthio or ethylthio.

Alkylsulfinyl (alkyl-SO—) is, for example, methylsulfinyl, ethylsulfinyl, propylsulfinyl, isopropylsulfinyl, n-butylsulfinyl, isobutylsulfinyl, sec-butylsulfinyl or tert-butylsulfinyl, preferably methylsulfinyl or ethylsulfinyl.

Alkylsulfonyl (alkyl-S(O)₂—) is, for example, methylsulfonyl, ethylsulfonyl, propylsulfonyl, isopropylsulfonyl, n-butylsulfonyl, isobutylsulfonyl, sec-butylsulfonyl or tert-butylsulfonyl, preferably methylsulfonyl or ethylsulfonyl.

Alkylamino (alkyl-NH—) is, for example, methylamino, ethylamino, n-propylamino, isopropylamino or a butylamino isomer. Dialkylamino ((alkyl)₂-N—) is, for example, dimethylamino, methylethylamino, diethylamino, n-propylmethylamino, dibutylamino or diisopropylamino. Preference is given to alkylamino groups having a chain length of from 1 to 4 carbon atoms.

Cycloalkylamino or dicycloalkylamino is for example cyclohexylamino or dicyclopropylamino.

Alkoxyalkyl groups preferably have from 1 to 6 carbon atoms. Alkoxyalkyl is, for example, methoxymethyl, methoxyethyl, ethoxymethyl, ethoxyethyl, n-propoxymethyl, n-propoxyethyl, isopropoxymethyl or isopropoxyethyl.

Alkylthioalkyl groups preferably have from 1 to 6 carbon atoms. Alkylthioalkyl is, for example, methylthiomethyl, methylthioethyl, ethylthiomethyl, ethylthioethyl, n-propylthiomethyl, n-propylthioethyl, isopropylthiomethyl, isopropylthioethyl, butylthiomethyl, butylthioethyl or butylthiobutyl.

Cycloalkyl groups preferably have from 3 to 6 ring carbon atoms and may be substituted by one or more methyl groups; they are preferably unsubstituted, for example cyclopropyl, cyclobutyl, cyclopentyl or cyclohexyl.

Aryl includes benzyl, phenyl, including phenyl as part of a substituent such as phenoxy, benzyl, benzyloxy, benzoyl, phenylthio, phenylalkyl, phenoxyalkyl or tosyl, may be in mono- or poly-substituted form, in which case the substituents may, as desired, be in the ortho-, meta- and/or para-position(s). The term also includes, for example, naphthalenyl.

Heterocyclyl, includes, for example, morpholinyl, tetrahydrofuryl and heteroaryl.

Heteroaryl, including heteroaryl as part of a substituent such as heteroaryloxy, means, for example, a five to ten (preferably five or six) member heteroaryl containing one to three heteroatoms, each independently selected from the group consisting of oxygen, nitrogen and sulphur. The term heteroaryl thus includes, for example, benzofuranyl, benzimidazolyl, indolyl, isobenzofuranyl, furanyl, thiophenyl, thiazolyl, oxazolyl, isoxazolyl, thiazolyl, pyrazolyl, isothiazolyl, pyridyl, pyridazinyl, pyrazinyl, pyrimidinyl, pyridonyl, triazolyl, napthyridinyl and napthyridinonyl. The heteroaryl component may be optionally mono or poly substituted as previously defined.

Preferably, R¹ is selected from the group consisting of A1a, A1b, A1c, A1d, A2a, A2b and A2c:

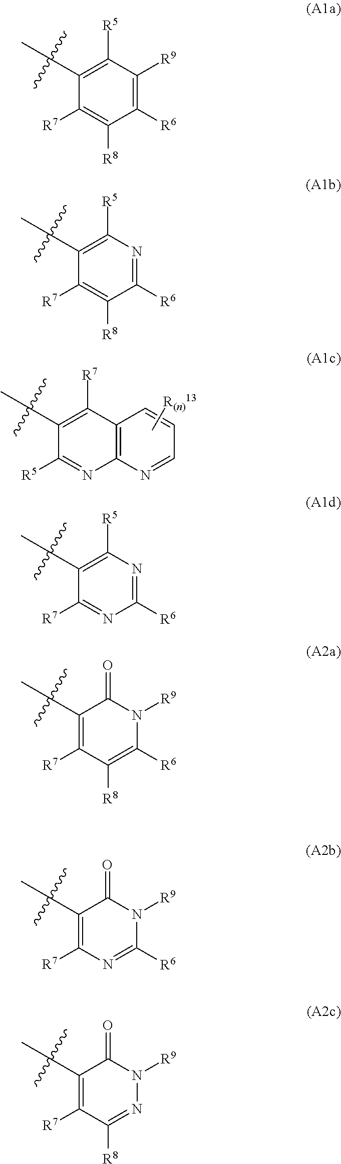

wherein R⁵, R⁶, R⁷, R⁸, R⁹ and R¹³ are as defined in claim 1 and n is 0, 1, 2 or 3.

More preferably, R¹ is selected from the group consisting of phenyl (e.g. A1a) and 3-pyridyl (e.g. A1b). Even more preferably R¹ is phenyl (e.g. A1a).

Preferably, R² is selected from the group consisting of hydrogen, C₁-C₆alkyl, C₂-C₆alkenyl, C₂-C₆alkynyl, C₃-C₆cycloalkyl, C₁-C₆haloalkyl C₁-C₆alkoxy-C₁-C₃alkyl and C₃-C₆cycloalkyl-C₁-C₃alkyl. More preferably, R² is selected from the group consisting of hydrogen, amino, chloro, bromo, methyl, ethyl, isopropyl, vinyl, propargyl, isopropenyl, methyl-S(O)ₚ—, cyclopropyl, and cyano. Most preferably, R² is vinyl or methyl.

Preferably, R³ is selected from the group consisting of hydrogen, halo, cyano, C₁-C₆alkyl, C₂-C₆alkenyl, C₂-C₆alkynyl, C₁-C₆haloalkyl and C₁-C₆alkyl-S(O)ₚ—. More preferably, R³ is selected from the group consisting of hydrogen, halo and C₁-C₆alkyl, most preferably hydrogen.

Preferably, R⁴ is hydrogen.

Preferably, both R³ and R⁴ are hydrogen.

Preferably, R⁵ is selected from the group consisting of hydroxyl, halo, C₁-C₆alkyl, C₁-C₆cycloalkyl, C₁-C₆haloalkyl, C₁-C₆alkenyl, C₁-C₆alkynyl, C₁-C₆ alkoxy, C₁-C₆ alkoxyC₁-C₃alkyl, C₁-C₆ alkoxy-C₂-C₆alkoxy, C₁-C₆ alkoxy-C₂-C₆alkoxy-C₁-C₃alkyl, C₁-C₆ haloalkoxy, C₁-C₆ haloalkoxy-C₁-C₃alkyl, C₁-C₆alkyl-S(O)p-, C₁-C₆haloalkyl-S(O)p-, aryl, aryloxy, heterocyclyl, heterocyclyl-C₁-C₃alkoxy-C₁-C₃alkyl, C₁-C₃alkylamino-, C₁-C₃dialkylamino-, C₁-C₃ alkylamino-S(O)p-, C₁-C₃ alkylamino-S(O)p-C₁-C₃alkyl-, C₁-C₃ dialkylamino-S(O)p-, C₁-C₃ dialkylamino-S(O)p-C₁-C₃alkyl-, C₁-C₃alkylaminocarbonyl-, C₁-C₃dialkylaminocarbonyl-, C₁-C₃ dialkylaminocarbonyl-C₁-C₃alkyl-, C₁-C₃alkylcarbonylamino-, C₁-C₃ alkyl-S(O)ₚ-amino-, cyano and nitro, wherein said heterocyclyls are five or six membered heterocyclyls containing from one to three heteroatoms each independently selected from the group consisting of oxygen, nitrogen and sulphur, and wherein the aryl or heterocyclyl components may be optionally substituted by one or more substituents selected from the group consisting of halo, C₁-C₃alkyl, C₁-C₃haloalkyl, C₁-C₃ alkoxy, C₁-C₃ haloalkoxy, cyano and nitro.

The terms “aryl” and “heterocyclyl” are further defined above. However, in the context of R⁵ phenyl, benzyl, isoxazolinyl, pyrimidinyl, morpholinyl, furyl and thiophenyl are particularly preferred.

More preferably, R⁵ is selected from the group consisting of chloro, fluoro, methyl, trifluoromethyl, 2-fluoroethyl-, methoxyethoxymethyl-, trifluoromethoxymethyl-, methylS(O)p-, aryl, isoxazolinyl, morpholinyl, methyl-S(O)p-dimethylamino-, cyano and nitro, wherein the aryl or heterocyclyl components may be optionally substituted by one or more substituents selected from the group consisting of chloro, methyl or trifluoromethyl. Even more preferably, R⁵ is selected from the group consisting of chloro, methyl, trifluoromethyl, and methyl-S(O)ₚ—.

Preferably, R⁶ is selected from the group consisting of hydrogen, halogen, C₁-C₆alkyl, C₁-C₆haloalkyl, C₁-C₆alkyl-S(O)ₚ—, C₁-C₆cycloalkyl, C₂-C₆alkenyl, C₂-C₆haloalkenyl, C₂-C₆alkynyl, C₁-C₆ alkoxy-, C₁-C₆haloalkoxy, C₂-C₆alkenyloxy-, C₃-C₆cycloalkylC₁-C₃-alkyl-, C₁-C₆ alkoxyC₁-C₃alkyl-, C₁-C₆ alkoxy-C₂-C₆alkoxy-, nitro and phenyl wherein the phenyl may be optionally substituted by one or more substituents selected from the group consisting of halo, C₁-C₃alkyl, C₁-C₃haloalkyl, C₁-C₃ alkoxy, C₁-C₃ haloalkoxy, C₁-C₆alkyl-S(O)ₚ—, phenyl, cyano and nitro. More preferably, R⁶ is selected from the group consisting of hydrogen, halogen, C₁-C₆alkyl, C₁-C₆haloalkyl, C₁-C₆alkyl-S(O)ₚ—, C₂-C₆alkenyl and C₂-C₆alkynyl. Even more preferably, R⁶ is selected from the group consisting of methyl, ethyl, chloro, trifluoromethyl, and methyl-S(O)ₚ—.

Preferably, R⁷ is selected from the group consisting of hydrogen, halogen and C₁-C₃ alkyl-. Most preferably R⁷ is hydrogen.

Preferably, R⁸ is selected from the group consisting of hydrogen, halogen and C₁-C₃ alkyl-. Most preferably R⁸ is hydrogen.

Preferably, R⁹ is selected from the group consisting of hydrogen, halogen, C₁-C₆alkyl, C₁-C₆haloalkyl, C₁-C₆alkyl-S(O)ₚ—, C₁-C₆cycloalkyl, C₂-C₆alkenyl, C₂-C₆haloalkenyl, C₂-C₆alkynyl, C₁-C₆ alkoxy-, C₁-C₆haloalkoxy, C₂-C₆alkenyloxy-, C₃-C₆cycloalkylC₁-C₃-alkyl-, C₁-C₆ alkoxyC₁-C₃alkyl-, C₁-C₆ alkoxy-C₂-C₆alkoxy-, nitro, 4,5-dihydroisoxazol-3-yl and phenyl wherein the phenyl may be optionally substituted by one or more substituents selected from the group consisting of halo, C₁-C₃alkyl, C₁-C₃haloalkyl, C₁-C₃ alkoxy, C₁-C₃ haloalkoxy, C₁-C₆alkyl-S(O)ₚ—, phenyl, cyano and nitro. More preferably, R⁹ is selected from the group consisting of hydrogen, 4,5-dihydroisoxazol-3-yl, halogen, C₁-C₆alkyl, C₁-C₆haloalkyl, C₁-C₆alkyl-S(O)ₚ—, C₂-C₆alkenyl and C₂-C₆alkynyl. Even more preferably R⁹ is hydrogen or 4,5-dihydroisoxazol-3-yl.

Preferably, R¹³ is hydrogen or methyl.

Compounds of Formula I may contain asymmetric centres and may be present as a single enantiomer, pairs of enantiomers in any proportion or, where more than one asymmetric centre are present, contain diastereoisomers in all possible ratios. Typically one of the enantiomers has enhanced biological activity compared to the other possibilities.

Similarly, where there are disubstituted alkenes, these may be present in E or Z form or as mixtures of both in any proportion.

Furthermore, compounds of Formula I may be in equilibrium with alternative hydroxyl tautomeric forms. It should be appreciated that all tautomeric forms (single tautomer or mixtures thereof), racemic mixtures and single isomers are included within the scope of the present invention.

The present invention also includes agronomically acceptable salts that the compounds of Formula I may form with amines (for example ammonia, dimethylamine and triethylamine), alkali metal and alkaline earth metal bases or quaternary ammonium bases. Among the alkali metal and alkaline earth metal hydroxides, oxides, alkoxides and hydrogen carbonates and carbonates used as salt formers, emphasis is to be given to the hydroxides, alkoxides, oxides and carbonates of lithium, sodium, potassium, magnesium and calcium, but especially those of sodium, magnesium and calcium. The corresponding trimethylsulfonium salt may also be used.

The compounds of Formula (I) according to the invention can be used as herbicides by themselves, but they are generally formulated into herbicidal compositions using formulation adjuvants, such as carriers, solvents and surface-active agents (SFAs). Thus, the present invention further provides a herbicidal composition comprising a herbicidal compound according to any one of the previous claims and an agriculturally acceptable formulation adjuvant. The composition can be in the form of concentrates which are diluted prior to use, although ready-to-use compositions can also be made. The final dilution is usually made with water, but can be made instead of, or in addition to, water, with, for example, liquid fertilisers, micronutrients, biological organisms, oil or solvents.

The herbicidal compositions generally comprise from 0.1 to 99% by weight, especially from 0.1 to 95% by weight, compounds of Formula I and from 1 to 99.9% by weight of a formulation adjuvant which preferably includes from 0 to 25% by weight of a surface-active substance.

The compositions can be chosen from a number of formulation types, many of which are known from the Manual on Development and Use of FAO Specifications for Plant Protection Products, 5th Edition, 1999. These include dustable powders (DP), soluble powders (SP), water soluble granules (SG), water dispersible granules (WG), wettable powders (WP), granules (GR) (slow or fast release), soluble concentrates (SL), oil miscible liquids (OL), ultra low volume liquids (UL), emulsifiable concentrates (EC), dispersible concentrates (DC), emulsions (both oil in water (EW) and water in oil (EO)), micro-emulsions (ME), suspension concentrates (SC), aerosols, capsule suspensions (CS) and seed treatment formulations. The formulation type chosen in any instance will depend upon the particular purpose envisaged and the physical, chemical and biological properties of the compound of Formula (I).

Dustable powders (DP) may be prepared by mixing a compound of Formula (I) with one or more solid diluents (for example natural clays, kaolin, pyrophyllite, bentonite, alumina, montmorillonite, kieselguhr, chalk, diatomaceous earths, calcium phosphates, calcium and magnesium carbonates, sulphur, lime, flours, talc and other organic and inorganic solid carriers) and mechanically grinding the mixture to a fine powder.

Soluble powders (SP) may be prepared by mixing a compound of Formula (I) with one or more water-soluble inorganic salts (such as sodium bicarbonate, sodium carbonate or magnesium sulphate) or one or more water-soluble organic solids (such as a polysaccharide) and, optionally, one or more wetting agents, one or more dispersing agents or a mixture of said agents to improve water dispersibility/solubility. The mixture is then ground to a fine powder. Similar compositions may also be granulated to form water soluble granules (SG).

Wettable powders (WP) may be prepared by mixing a compound of Formula (I) with one or more solid diluents or carriers, one or more wetting agents and, preferably, one or more dispersing agents and, optionally, one or more suspending agents to facilitate the dispersion in liquids. The mixture is then ground to a fine powder. Similar compositions may also be granulated to form water dispersible granules (WG).

Granules (GR) may be formed either by granulating a mixture of a compound of Formula (I) and one or more powdered solid diluents or carriers, or from pre-formed blank granules by absorbing a compound of Formula (I) (or a solution thereof, in a suitable agent) in a porous granular material (such as pumice, attapulgite clays, fuller's earth, kieselguhr, diatomaceous earths or ground corn cobs) or by adsorbing a compound of Formula (I) (or a solution thereof, in a suitable agent) on to a hard core material (such as sands, silicates, mineral carbonates, sulphates or phosphates) and drying if necessary. Agents which are commonly used to aid absorption or adsorption include solvents (such as aliphatic and aromatic petroleum solvents, alcohols, ethers, ketones and esters) and sticking agents (such as polyvinyl acetates, polyvinyl alcohols, dextrins, sugars and vegetable oils). One or more other additives may also be included in granules (for example an emulsifying agent, wetting agent or dispersing agent).

Dispersible Concentrates (DC) may be prepared by dissolving a compound of Formula (I) in water or an organic solvent, such as a ketone, alcohol or glycol ether. These solutions may contain a surface active agent (for example to improve water dilution or prevent crystallisation in a spray tank).

Emulsifiable concentrates (EC) or oil-in-water emulsions (EW) may be prepared by dissolving a compound of Formula (I) in an organic solvent (optionally containing one or more wetting agents, one or more emulsifying agents or a mixture of said agents). Suitable organic solvents for use in ECs include aromatic hydrocarbons (such as alkylbenzenes or alkylnaphthalenes, exemplified by SOLVESSO 100, SOLVESSO 150 and SOLVESSO 200; SOLVESSO is a Registered Trade Mark), ketones (such as cyclohexanone or methylcyclohexanone) and alcohols (such as benzyl alcohol, furfuryl alcohol or butanol), N-alkylpyrrolidones (such as N-methylpyrrolidone or N-octylpyrrolidone), dimethyl amides of fatty acids (such as C₈-C₁₀ fatty acid dimethylamide) and chlorinated hydrocarbons. An EC product may spontaneously emulsify on addition to water, to produce an emulsion with sufficient stability to allow spray application through appropriate equipment.

Preparation of an EW involves obtaining a compound of Formula (I) either as a liquid (if it is not a liquid at room temperature, it may be melted at a reasonable temperature, typically below 70° C.) or in solution (by dissolving it in an appropriate solvent) and then emulsifying the resultant liquid or solution into water containing one or more SFAs, under high shear, to produce an emulsion. Suitable solvents for use in EWs include vegetable oils, chlorinated hydrocarbons (such as chlorobenzenes), aromatic solvents (such as alkylbenzenes or alkylnaphthalenes) and other appropriate organic solvents which have a low solubility in water.

Microemulsions (ME) may be prepared by mixing water with a blend of one or more solvents with one or more SFAs, to produce spontaneously a thermodynamically stable isotropic liquid formulation. A compound of Formula (I) is present initially in either the water or the solvent/SFA blend. Suitable solvents for use in MEs include those hereinbefore described for use in ECs or in EWs. An ME may be either an oil-in-water or a water-in-oil system (which system is present may be determined by conductivity measurements) and may be suitable for mixing water-soluble and oil-soluble pesticides in the same formulation. An ME is suitable for dilution into water, either remaining as a microemulsion or forming a conventional oil-in-water emulsion.

Suspension concentrates (SC) may comprise aqueous or non-aqueous suspensions of finely divided insoluble solid particles of a compound of Formula (I). SCs may be prepared by ball or bead milling the solid compound of Formula (I) in a suitable medium, optionally with one or more dispersing agents, to produce a fine particle suspension of the compound. One or more wetting agents may be included in the composition and a suspending agent may be included to reduce the rate at which the particles settle. Alternatively, a compound of Formula (I) may be dry milled and added to water, containing agents hereinbefore described, to produce the desired end product.

Aerosol formulations comprise a compound of Formula (I) and a suitable propellant (for example n-butane). A compound of Formula (I) may also be dissolved or dispersed in a suitable medium (for example water or a water miscible liquid, such as n-propanol) to provide compositions for use in non-pressurised, hand-actuated spray pumps.

Capsule suspensions (CS) may be prepared in a manner similar to the preparation of EW formulations but with an additional polymerisation stage such that an aqueous dispersion of oil droplets is obtained, in which each oil droplet is encapsulated by a polymeric shell and contains a compound of Formula (I) and, optionally, a carrier or diluent therefor. The polymeric shell may be produced by either an interfacial polycondensation reaction or by a coacervation procedure. The compositions may provide for controlled release of the compound of Formula (I) and they may be used for seed treatment. A compound of Formula (I) may also be formulated in a biodegradable polymeric matrix to provide a slow, controlled release of the compound.

The composition may include one or more additives to improve the biological performance of the composition, for example by improving wetting, retention or distribution on surfaces; resistance to rain on treated surfaces; or uptake or mobility of a compound of Formula (I). Such additives include surface active agents (SFAs), spray additives based on oils, for example certain mineral oils or natural plant oils (such as soy bean and rape seed oil), and blends of these with other bio-enhancing adjuvants (ingredients which may aid or modify the action of a compound of Formula (I)).

Wetting agents, dispersing agents and emulsifying agents may be SFAs of the cationic, anionic, amphoteric or non-ionic type.

Suitable SFAs of the cationic type include quaternary ammonium compounds (for example cetyltrimethyl ammonium bromide), imidazolines and amine salts.

Suitable anionic SFAs include alkali metals salts of fatty acids, salts of aliphatic monoesters of sulphuric acid (for example sodium lauryl sulphate), salts of sulphonated aromatic compounds (for example sodium dodecylbenzenesulphonate, calcium dodecylbenzenesulphonate, butylnaphthalene sulphonate and mixtures of sodium di-isopropyl- and tri-isopropyl-naphthalene sulphonates), ether sulphates, alcohol ether sulphates (for example sodium laureth-3-sulphate), ether carboxylates (for example sodium laureth-3-carboxylate), phosphate esters (products from the reaction between one or more fatty alcohols and phosphoric acid (predominately mono-esters) or phosphorus pentoxide (predominately di-esters), for example the reaction between lauryl alcohol and tetraphosphoric acid; additionally these products may be ethoxylated), sulphosuccinamates, paraffin or olefine sulphonates, taurates and lignosulphonates.

Suitable SFAs of the amphoteric type include betaines, propionates and glycinates.

Suitable SFAs of the non-ionic type include condensation products of alkylene oxides, such as ethylene oxide, propylene oxide, butylene oxide or mixtures thereof, with fatty alcohols (such as oleyl alcohol or cetyl alcohol) or with alkylphenols (such as octylphenol, nonylphenol or octylcresol); partial esters derived from long chain fatty acids or hexitol anhydrides; condensation products of said partial esters with ethylene oxide; block polymers (comprising ethylene oxide and propylene oxide); alkanolamides; simple esters (for example fatty acid polyethylene glycol esters); amine oxides (for example lauryl dimethyl amine oxide); and lecithins.

Suitable suspending agents include hydrophilic colloids (such as polysaccharides, polyvinylpyrrolidone or sodium carboxymethylcellulose) and swelling clays (such as bentonite or attapulgite).

The composition of the present may further comprise at least one additional pesticide. For example, the compounds according to the invention can also be used in combination with other herbicides or plant growth regulators. In a preferred embodiment the additional pesticide is a herbicide and/or herbicide safener. Examples of such mixtures are (in which ‘I’ represents a compound of Formula I). I+acetochlor, I+acifluorfen, I+acifluorfen-sodium, I+aclonifen, I+acrolein, I+alachlor, I+alloxydim, I+ametryn, I+amicarbazone, I+amidosulfuron, I+aminopyralid, I+amitrole, I+anilofos, I+asulam, I+atrazine, I+azafenidin, I+azimsulfuron, I+BCPC, I+beflubutamid, I+benazolin, I+bencarbazone, I+benfluralin, I+benfuresate, I+bensulfuron, I+bensulfuron-methyl, I+bensulide, I+bentazone, I+benzfendizone, I+benzobicyclon, I+benzofenap, I+bicyclopyrone, I+bifenox, I+bilanafos, I+bispyribac, I+bispyribac-sodium, I+borax, I+bromacil, I+bromobutide, I+bromoxynil, I+butachlor, I+butamifos, I+butralin, I+butroxydim, I+butylate, I+cacodylic acid, I+calcium chlorate, I+cafenstrole, I+carbetamide, I+carfentrazone, I+carfentrazone-ethyl, I+chlorflurenol, I+chlorflurenol-methyl, I+chloridazon, I+chlorimuron, I+chlorimuron-ethyl, I+chloroacetic acid, I+chlorotoluron, I+chlorpropham, I+chlorsulfuron, I+chlorthal, I+chlorthal-dimethyl, I+cinidon-ethyl, I+cinmethylin, I+cinosulfuron, I+cisanilide, I+clethodim, I+clodinafop, I+clodinafop-propargyl, I+clomazone, I+clomeprop, I+clopyralid, I+cloransulam, I+cloransulam-methyl, I+cyanazine, I+cycloate, I+cyclosulfamuron, I+cycloxydim, I+cyhalofop, I+cyhalofop-butyl, I+2,4-D, I+daimuron, I+dalapon, I+dazomet, I+2,4-DB, I+I+desmedipham, I+dicamba, I+dichlobenil, I+dichlorprop, I+dichlorprop-P, I+diclofop, I+diclofop-methyl, I+diclosulam, I+difenzoquat, I+difenzoquat metilsulfate, I+diflufenican, I+diflufenzopyr, I+dimefuron, I+dimepiperate, I+dimethachlor, I+dimethametryn, I+dimethenamid, I+dimethenamid-P, I+dimethipin, I+dimethylarsinic acid, I+dinitramine, I+dinoterb, I+diphenamid, I+dipropetryn, I+diquat, I+diquat dibromide, I+dithiopyr, I+diuron, I+endothal, I+EPTC, I+esprocarb, I+ethalfluralin, I+ethametsulfuron, I+ethametsulfuron-methyl, I+ethephon, I+ethofumesate, I+ethoxyfen, I+ethoxysulfuron, I+etobenzanid, I+fenoxaprop-P, I+fenoxaprop-P-ethyl, I+fentrazamide, I+ferrous sulfate, I+flamprop-M, I+flazasulfuron, I+florasulam, I+fluazifop, I+fluazifop-butyl, I+fluazifop-P, I+fluazifop-P-butyl, I+fluazolate, I+flucarbazone, I+flucarbazone-sodium, I+flucetosulfuron, I+fluchloralin, I+flufenacet, I+flufenpyr, I+flufenpyr-ethyl, I+flumetralin, I+flumetsulam, I+flumiclorac, I+flumiclorac-pentyl, I+flumioxazin, I+flumipropin, I+fluometuron, I+fluoroglycofen, I+fluoroglycofen-ethyl, I+fluoxaprop, I+flupoxam, I+flupropacil, I+flupropanate, I+flupyrsulfuron, I+flupyrsulfuron-methyl-sodium, I+flurenol, I+fluridone, I+fluorochloridone, I+fluoroxypyr, I+flurtamone, I+fluthiacet, I+fluthiacet-methyl, I+fomesafen, I+foramsulfuron, I+fosamine, I+glufosinate, I+glufosinate-ammonium, I+glyphosate, I+halosulfuron, I+halosulfuron-methyl, I+haloxyfop, I+haloxyfop-P, I+hexazinone, I+imazamethabenz, I+imazamethabenz-methyl, I+imazamox, I+imazapic, I+imazapyr, I+imazaquin, I+imazethapyr, I+imazosulfuron, I+indanofan, I+indaziflam, I+iodomethane, I+iodosulfuron, I+iodosulfuron-methyl-sodium, I+ioxynil, I+isoproturon, I+isouron, I+isoxaben, I+isoxachlortole, I+isoxaflutole, I+isoxapyrifop, I+karbutilate, I+lactofen, I+lenacil, I+linuron, I+mecoprop, I+mecoprop-P, I+mefenacet, I+mefluidide, I+mesosulfuron, I+mesosulfuron-methyl, I+mesotrione, I+metam, I+metamifop, I+metamitron, I+metazachlor, I+methabenzthiazuron, I+methazole, I+methylarsonic acid, I+methyldymron, I+methyl isothiocyanate, I+metolachlor, I+S-metolachlor, I+metosulam, I+metoxuron, I+metribuzin, I+metsulfuron, I+metsulfuron-methyl, I+molinate, I+monolinuron, I+naproanilide, I+napropamide, I+naptalam, I+neburon, I+nicosulfuron, I+n-methyl glyphosate, I+nonanoic acid, I+norflurazon, I+oleic acid (fatty acids), I+orbencarb, I+orthosulfamuron, I+oryzalin, I+oxadiargyl, I+oxadiazon, I+oxasulfuron, I+oxaziclomefone, I+oxyfluorfen, I+paraquat, I+paraquat dichloride, I+pebulate, I+pendimethalin, I+penoxsulam, I+pentachlorophenol, I+pentanochlor, I+pentoxazone, I+pethoxamid, I+phenmedipham, I+picloram, I+picolinafen, I+pinoxaden, I+piperophos, I+pretilachlor, I+primisulfuron, I+primisulfuron-methyl, I+prodiamine, I+profoxydim, I+prohexadione-calcium, I+prometon, I+prometryn, I+propachlor, I+propanil, I+propaquizafop, I+propazine, I+propham, I+propisochlor, I+propoxycarbazone, I+propoxycarbazone-sodium, I+propyzamide, I+prosulfocarb, I+prosulfuron, I+pyraclonil, I+pyraflufen, I+pyraflufen-ethyl, I+pyrasulfotole, I+pyrazolynate, I+pyrazosulfuron, I+pyrazosulfuron-ethyl, I+pyrazoxyfen, I+pyribenzoxim, I+pyributicarb, I+pyridafol, I+pyridate, I+pyriftalid, I+pyriminobac, I+pyriminobac-methyl, I+pyrimisulfan, I+pyrithiobac, I+pyrithiobac-sodium, I+pyroxasulfone, I+pyroxsulam, I+quinclorac, I+quinmerac, I+quinoclamine, I+quizalofop, I+quizalofop-P, I+rimsulfuron, I+saflufenacil, I+sethoxydim, I+siduron, I+simazine, I+simetryn, I+sodium chlorate, I+sulcotrione, I+sulfentrazone, I+sulfometuron, I+sulfometuron-methyl, I+sulfosate, I+sulfosulfuron, I+sulfuric acid, I+tebuthiuron, I+tefuryltrione, I+tembotrione, I+tepraloxydim, I+terbacil, I+terbumeton, I+terbuthylazine, I+terbutryn, I+thenylchlor, I+thiazopyr, I+thifensulfuron, I+thiencarbazone, I+thifensulfuron-methyl, I+thiobencarb, I+topramezone, I+tralkoxydim, I+tri-allate, I+triasulfuron, I+triaziflam, I+tribenuron, I+tribenuron-methyl, I+triclopyr, I+trietazine, I+trifloxysulfuron, I+trifloxysulfuron-sodium, I+trifluralin, I+triflusulfuron, I+triflusulfuron-methyl, I+trihydroxytriazine, I+trinexapac-ethyl, I+tritosulfuron, I+[3-[2-chloro-4-fluoro-5-(1-methyl-6-trifluoromethyl-2,4-dioxo-1,2,3,4-tetrahydropyrimidin-3-yl)phenoxy]-2-pyridyloxy]acetic acid ethyl ester (CAS RN 353292-31-6). The compounds of the present invention may also be combined with herbicidal compounds disclosed in WO06/024820 and/or WO07/096,576.

The mixing partners of the compound of Formula I may also be in the form of esters or salts, as mentioned e.g. in The Pesticide Manual, Fourteenth Edition, British Crop Protection Council, 2006.

The compound of Formula I can also be used in mixtures with other agrochemicals such as fungicides, nematicides or insecticides, examples of which are given in The Pesticide Manual.

The mixing ratio of the compound of Formula I to the mixing partner is preferably from 1:100 to 1000:1.

The mixtures can advantageously be used in the above-mentioned formulations (in which case “active ingredient” relates to the respective mixture of compound of Formula I with the mixing partner).

The compounds of Formula I according to the invention can also be used in combination with one or more safeners. Likewise, mixtures of a compound of Formula I according to the invention with one or more further herbicides can also be used in combination with one or more safeners. The safeners can be AD 67 (MON 4660), benoxacor, cloquintocet-mexyl, cyprosulfamide (CAS RN 221667-31-8), dichlormid, fenchlorazole-ethyl, fenclorim, fluxofenim, furilazole and the corresponding R isomer, isoxadifen-ethyl, mefenpyr-diethyl, oxabetrinil, N-isopropyl-4-(2-methoxy-benzoylsulfamoyl)-benzamide (CAS RN 2 2 1 6 6 8-34-4). Other possibilities include safener compounds disclosed in, for example, EP0365484 e.g N-(2-methoxybenzoyl)-4-[(methylaminocarbonyl)amino]benzenesulfonamide. Particularly preferred are mixtures of a compound of Formula I with cyprosulfamide, isoxadifen-ethyl, cloquintocet-mexyl and/or N-(2-methoxybenzoyl)-4-[(methyl-aminocarbonyl)amino]benzenesulfonamide.

The safeners of the compound of Formula I may also be in the form of esters or salts, as mentioned e.g. in The Pesticide Manual, 14^{th} Edition (BCPC), 2006. The reference to cloquintocet-mexyl also applies to a lithium, sodium, potassium, calcium, magnesium, aluminium, iron, ammonium, quaternary ammonium, sulfonium or phosphonium salt thereof as disclosed in WO 02/34048, and the reference to fenchlorazole-ethyl also applies to fenchlorazole, etc.

Preferably the mixing ratio of compound of Formula I to safener is from 100:1 to 1:10, especially from 20:1 to 1:1.

The mixtures can advantageously be used in the above-mentioned formulations (in which case “active ingredient” relates to the respective mixture of compound of Formula I with the safener).

The present invention still further provides a method of selectively controlling weeds at a locus comprising crop plants and weeds, wherein the method comprises application to the locus of a weed controlling amount of a composition according to the present invention. ‘Controlling’ means killing, reducing or retarding growth or preventing or reducing germination. Generally the plants to be controlled are unwanted plants (weeds). ‘Locus’ means the area in which the plants are growing or will grow.

The rates of application of compounds of Formula I may vary within wide limits and depend on the nature of the soil, the method of application (pre- or post-emergence; seed dressing; application to the seed furrow; no tillage application etc.), the crop plant, the weed(s) to be controlled, the prevailing climatic conditions, and other factors governed by the method of application, the time of application and the target crop. The compounds of Formula I according to the invention are generally applied at a rate of from 10 to 2000 g/ha, especially from 50 to 1000 g/ha.

The application is generally made by spraying the composition, typically by tractor mounted sprayer for large areas, but other methods such as dusting (for powders), drip or drench can also be used.

Useful plants in which the composition according to the invention can be used include crops such as cereals, for example barley and wheat, cotton, oilseed rape, sunflower, maize, rice, soybeans, sugar beet, sugar cane and turf Maize is particularly preferred.

Crop plants can also include trees, such as fruit trees, palm trees, coconut trees or other nuts. Also included are vines such as grapes, fruit bushes, fruit plants and vegetables.

Crops are to be understood as also including those crops which have been rendered tolerant to herbicides or classes of herbicides (e.g. ALS-, GS-, EPSPS-, PPO-, ACCase- and HPPD-inhibitors) by conventional methods of breeding or by genetic engineering. An example of a crop that has been rendered tolerant to imidazolinones, e.g. imazamox, by conventional methods of breeding is Clearfield® summer rape (canola). Examples of crops that have been rendered tolerant to herbicides by genetic engineering methods include e.g. glyphosate- and glufosinate-resistant maize varieties commercially available under the trade names RoundupReady® and LibertyLink®.

In a preferred embodiment the crop plant is rendered tolerant to HPPD-inhibitors via genetic engineering. Methods of rending crop plants tolerant to HPPD-inhibitors are known, for example from WO0246387. Thus in an even more preferred embodiment the crop plant is transgenic in respect of a polynucleotide comprising a DNA sequence which encodes an HPPD-inhibitor resistant HPPD enzyme derived from a bacterium, more particularly from Pseudomonas fluorescens or Shewanella colwelliana, or from a plant, more particularly, derived from a monocot plant or, yet more particularly, from a barley, maize, wheat, rice, Brachiaria, Chenchrus, Lolium, Festuca, Setaria, Eleusine, Sorghum or Avena species.

Crops are also to be understood as being those which have been rendered resistant to harmful insects by genetic engineering methods, for example Bt maize (resistant to European corn borer), Bt cotton (resistant to cotton boll weevil) and also Bt potatoes (resistant to Colorado beetle). Examples of Bt maize are the Bt 176 maize hybrids of NK® (Syngenta Seeds). The Bt toxin is a protein that is formed naturally by Bacillus thuringiensis soil bacteria. Examples of toxins, or transgenic plants able to synthesise such toxins, are described in EP-A-451 878, EP-A-374 753, WO 93/07278, WO 95/34656, WO 03/052073 and EP-A-427 529. Examples of transgenic plants comprising one or more genes that code for an insecticidal resistance and express one or more toxins are KnockOut® (maize), Yield Gard® (maize), NuCOTIN33B® (cotton), Bollgard® (cotton), NewLeaf® (potatoes), NatureGard® and Protexcta®. Plant crops or seed material thereof can be both resistant to herbicides and, at the same time, resistant to insect feeding (“stacked” transgenic events). For example, seed can have the ability to express an insecticidal Cry3 protein while at the same time being tolerant to glyphosate.

Crops are also to be understood to include those which are obtained by conventional methods of breeding or genetic engineering and contain so-called output traits (e.g. improved storage stability, higher nutritional value and improved flavour).

Other useful plants include turf grass for example in golf-courses, lawns, parks and roadsides, or grown commercially for sod, and ornamental plants such as flowers or bushes.

The compositions can be used to control unwanted plants (collectively, ‘weeds’). The weeds to be controlled may be both monocotyledonous species, for example Agrostis, Alopecurus, Avena, Brachiaria, Bromus, Cenchrus, Cyperus, Digitaria, Echinochloa, Eleusine, Lolium, Monochoria, Rottboellia, Sagittaria, Scirpus, Setaria and Sorghum, and dicotyledonous species, for example Abutilon, Amaranthus, Ambrosia, Chenopodium, Chrysanthemum, Conyza, Galium, Ipomoea, Nasturtium, Sida, Sinapis, Solanum, Stellaria, Veronica, Viola and Xanthium. Weeds can also include plants which may be considered crop plants but which are growing outside a crop area (‘escapes’), or which grow from seed left over from a previous planting of a different crop (‘volunteers’). Such volunteers or escapes may be tolerant to certain other herbicides.

The compounds of the present invention can be prepared using the following methods.

Compounds of formula (1a) may be prepared from compounds of formula (I) as shown in reaction scheme 1.

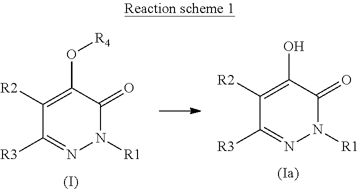

Compounds of formula (1a), in which R⁴ is hydrogen, may be prepared from compounds of formula 1 in which R⁴ is lower alkyl, for example methyl, by heating with morpholine (Nagashima, Hiromu et al. Heterocycles, 26(1), 1-4; 1987); or by reaction with boron tribromide in a suitable solvent such as dichloromethane.

Compounds of formula (1) may be prepared from compounds of formula (2) as shown in reaction scheme 2.

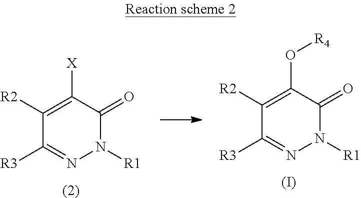

Compounds of formula (1) in which R⁴ is lower alkyl, for example methyl, may be prepared from compounds of formula (2), in which X is a suitable leaving group such as chlorine or bromine, by reaction with a suitable metal alkoxide, for example sodium methoxide, in a suitable solvent such as dioxane;

Compounds of formula (2) may be prepared from compounds of formula (3) as shown in reaction scheme 3.

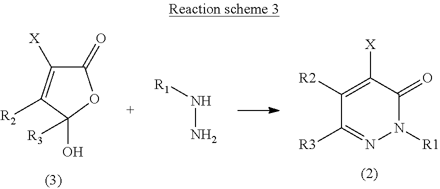

Compounds of formula (2) in which X is a suitable leaving group such as chlorine or bromine may be prepared from compounds of formula (3) by reaction with a suitable hydrazine in the presence of a suitable acidic solvent such as aqueous hydrochloric acid either with heating or microwave catalysis.

Compounds (3) in which R² and X are both chlorine or bromine, and R³ is hydrogen are commercially available.

Compounds (3) in which R² and R³ are as defined above may be prepared according to known procedures for example as disclosed in Bioorganic and Med. Chem., 2010, 18(14), 5224, Bioorganic and Med. Chem., 2008, 14(19), 9056 and WO03/093220.

Compounds of formula (2) may also be prepared from compounds of formula (2a) as show in reaction scheme 4

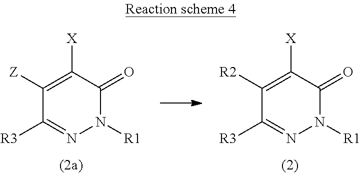

Compounds of formula (2) may be prepared from compounds of formula (2a) in which X and Z are halogens such as bromine, chlorine or iodine, by reaction with a suitable metal or metalloid derivative Y-M (e.g. a boronic acid or ester, a trialkyltin derivative, a zinc derivative or a Grignard reagent) in the presence of a suitable base (e.g. an inorganic base, such as potassium phosphate or caesium fluoride), a metal source (e.g. a palladium source, such as Pd (OAc)₂) and optionally a ligand for the metal (e.g. a phosphine ligand) in a suitable solvent (e.g. a single solvent, such as dimethylformamide, or a mixed solvent system such as a mixture of dimethoxyethane and water or toluene and water). The metal catalyst and ligands may also be added as a single, pre-formed complex (e.g. a palladium/phosphine complex, such as bis(triphenylphosphine)palladium dichloride or [1,1′-bis(diphenylphosphino)ferrocene]palladium dichloride dichloromethane adduct).

Compounds of formula (2a) may be prepared from compounds of formula (3a) as shown in reaction scheme 5.

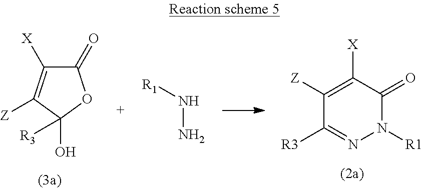

Compounds of formula (2a) in which X and Z are suitable leaving groups such as chlorine or bromine, may be prepared from compounds of formula (3a) by reaction with a suitable hydrazine in the presence of a suitable acidic solvent such as aqueous hydrochloric acid either with heating or microwave catalysis.

### EXAMPLES

### Example 1

### 2-[3-(4,5-dihydroisoxazol-3-yl)-2-methyl-4-methylsulfonyl-phenyl]-4-hydroxy-5-methylsulfanyl-pyridazin-3-one

### Step 1

### 4,5-dibromo-2-[3-(4,5-dihydroisoxazol-3-yl)-2-methyl-4-methylsulfonyl-phenyl]pyridazin-3-one

To a suspension of [3-(4,5-dihydroisoxazol-3-yl)-2-methyl-4-methylsulfonyl-phenyl]hydrazine (1.8 g, 6.7 mmol) in 4M hydrobromic acid (25 ml) was added 3,4-dibromo-2-hydroxy-2H-furan-5-one (2.1 f, 8.0 mmol) at 25° C. The solution was refluxed for 3 hours. The reaction mixture was extracted with ethyl acetate, washed with water, dried over anhydrous magnesium sulphate and concentrated under reduced pressure. The residue was purified by flash column chromatography on silica gel eluting with ethyl acetate in iso-hexane (0-100%), to give the 4,5-dibromo-2-[3-(4,5-dihydroisoxazol-3-yl)-2-methyl-4-methylsulfonyl-phenyl]pyridazin-3-one as a yellow solid (1.68 g).

1H NMR (CDCl₃):

8.1 (1H, d), 8.0 (1H, s), 7.55 (1H, d), 4.6 (2H, t), 3.35 (2H, br), 3.2 (3H, s), 2.1 (3H, s)

Aryl hydrazines such as [3-(4,5-dihydroisoxazol-3-yl)-2-methyl-4-methylsulfonyl-phenyl]hydrazine may be prepared from the corresponding bromide according to literature procedures e.g. as described in Tetrahedral Letters 40 (1999) 3543-3546, or from the aniline as described in Org. Synth. 1941, Coll. Vol. 1, 442. 3-(3-bromo-2-chloro-6-methylsulfonyl-phenyl)-4,5-dihydroisoxazole can be prepared as reported for example in DE 19820722. 3,4-dibromo-2-hydroxy-2H-furan-5-one is commercially available.

### Step 2

### 5-bromo-2-[3-(4,5-dihydroisoxazol-3-yl)-2-methyl-4-methylsulfonyl-phenyl]-4-methoxy-pyridazin-3-one

A solution of sodium methoxide in methanol (5.4 mol/l, 0.68 ml, 3.7 mmol) was added drop wise over 4 hours to a stirred solution of 4,5-dibromo-2-[3-(4,5-dihydroisoxazol-3-yl)-2-methyl-4-methylsulfonyl-phenyl]pyridazin-3-one (1.676 g, 3.412 mmol) in dioxane (20 ml) at room temperature under an atmosphere of nitrogen. The resulting mixture was stirred at room temperature for a further hour, and then poured into a mixture of water (50 ml) and dichloromethane (50 ml). The organic layer was separated and the aqueous layer extracted with dichloromethane (2×50 ml). The combined organic extracts were washed with water, then brine, dried over magnesium sulphate and concentrated under reduced pressure. The residue was purified by flash column chromatography on silica gel using ethyl acetate in iso-hexane (0-100%) as eluent, to give 5-bromo-2-[3-(4,5-dihydroisoxazol-3-yl)-2-methyl-4-methylsulfonyl-phenyl]-4-methoxy-pyridazin-3-one (600 mg as a white solid.

1H NMR (CDCl₃):

8.1 (1H, d), 8.0 (1H, s), 7.55 (1H, d), 4.6 (2H, t), 4.3 (3H, s), 3.35 (2H, br), 3.2 (3H, s), 2.1 (3H, s)

### Step 3

### 2-[3-(4,5-dihydroisoxazol-3-yl)-2-methyl-4-methylsulfonyl-phenyl]-4-methoxy-5-methylsulfanyl-pyridazin-3-one

The 5-bromo-2-[3-(4,5-dihydroisoxazol-3-yl)-2-methyl-4-methylsulfonyl-phenyl]-4-methoxy-pyridazin-3-one (200 mg, 0.45 mmol) was dissolved in N,N-dimethylformamide (5 ml, 64 mmol). Sodium thiomethoxide (40 mg, 0.54 mmol) was added and the reaction mixture quickly darkened in colour from yellow to red. LCMS after 2 hours showed good conversion to the desired product but there was still starting material present. More sodium thiomethoxide was added to drive the reaction to completion. Water and diethyl ether were added. The organic extracts were washed, dried over anhydrous magnesium sulphate and evaporated to yield a 1:1 mixture of 2-[3-(4,5-dihydroisoxazol-3-yl)-2-methyl-4-methylsulfonyl-phenyl]-4-methoxy-5-methylsulfanyl-pyridazin-3-one (60 mg, 0.15 mmol) and 2-[3-(4,5-dihydroisoxazol-3-yl)-2-methyl-4-methylsulfonyl-phenyl]-4,5-bis(methylsulfanyl)pyridazin-3-one (60 mg, 0.14 mmol) as a yellow solid.

This mixture was used directly without further purification in the following reaction.

### Step 4

### 2-[3-(4,5-dihydroisoxazol-3-yl)-2-methyl-4-methylsulfonyl-phenyl]-4-hydroxy-5-methylsulfanyl-pyridazin-3-one

2-[3-(4,5-dihydroisoxazol-3-yl)-2-methyl-4-methylsulfonyl-phenyl]-4-methoxy-5-methylsulfanyl-pyridazin-3-one (55 mg, 0.13 mmol) and 2-[3-(4,5-dihydroisoxazol-3-yl)-2-methyl-4-methylsulfonyl-phenyl]-4,5-bis(methylsulfanyl)pyridazin-3-one (55 mg, 0.13 mmol) were dissolved in acetonitrile (9 ml) in a 20 ml microwave tube and sodium iodide (100 mg, 0.67 mmol) was added. Chloro(trimethyl)silane (0.15 ml, 1.2 mmol) was added and the yellow reaction mixture immediately went red-orange. The reaction mixture was stirred in a microwave vial at 100° C. for 35 minutes and then was poured into water, basified with 2M aqueous sodium hydroxide and extracted into ether. The organic extracts were dried over anhydrous magnesium sulphate and evaporated to yield recovered 2-[3-(4,5-dihydroisoxazol-3-yl)-2-methyl-4-methylsulfonyl-phenyl]-4,5-bis(methylsulfanyl)pyridazin-3-one as a pale yellow solid (47 mg). The basic aqueous layer was acidified with 2M hydrochloric acid and extracted with dichloromethane. The organic extracts were washed with an aqueous solution of sodium metabisulphite and passed through a second phase separation cartridge, then evaporated to yield 2-[3-(4,5-dihydroisoxazol-3-yl)-2-methyl-4-methylsulfonyl-phenyl]-4-hydroxy-5-methylsulfanyl-pyridazin-3-one as a pale yellow solid (50 mg).

### Example 2

### 2-[3-(4,5-dihydroisoxazol-3-yl)-2-methyl-4-methylsulfonyl-phenyl]-4-hydroxy-5-methylsulfonyl-pyridazin-3-one

### Step 1

### 2-[3-(4,5-dihydroisoxazol-3-yl)-2-methyl-4-methylsulfonyl-phenyl]-4-hydroxy-5-methylsulfonyl-pyridazin-3-one

2-[3-(4,5-dihydroisoxazol-3-yl)-2-methyl-4-methylsulfonyl-phenyl]-4-hydroxy-5-methylsulfanyl-pyridazin-3-one (70 mg, 0.18 mmol) was dissolved in acetic acid (5 ml); hydrogen peroxide (0.4 ml, 1 mmol) was added, and the pale pink reaction mixture was heated at 50° C. for 2 hours. The reaction mixture was cooled and partitioned between water and dichloromethane. The organic extracts were separated and washed with saturated sodium hydrogen carbonate. The aqueous layer was very carefully acidified and re-extracted with dichloromethane. The combined organic extracts were passed through a phase-separation cartridge and evaporated to yield 2-[3-(4,5-dihydroisoxazol-3-yl)-2-methyl-4-methylsulfonyl-phenyl]-4-hydroxy-5-methylsulfonyl-pyridazin-3-one as a pinky-white solid (35 mg).

2-[3-(4,5-dihydroisoxazol-3-yl)-2-methyl-4-methylsulfonyl-phenyl]-4-hydroxy-5-methylsulfanyl-pyridazin-3-one was prepared as described in Example 1.

### Example 3

### 2-[3-(4,5-dihydroisoxazol-3-yl)-2-methyl-4-methylsulfonyl-phenyl]-4-hydroxy-5-methyl-pyridazin-3-one

### Step 1

### 2-[3-(4,5-dihydroisoxazol-3-yl)-2-methyl-4-methylsulfonyl-phenyl]-4-methoxy-5-methyl-pyridazin-3-one

A mixture of 5-bromo-2-[3-(4,5-dihydroisoxazol-3-yl)-2-methyl-4-methylsulfonyl-phenyl]-4-methoxy-pyridazin-3-one (200 mg, 0.45 mmol), -[3-(4,5-dihydroisoxazol-3-yl)-2-methyl-4-methylsulfonyl-phenyl]-4-methoxy-pyridazin-3-One, [1,1′bis(diphenylphosphino)ferrocene]palladium (II) dichloride dichloromethane adduct (80 mg, 0.09 mmol) in tetrahydrofuran (2 ml) was heated to reflux followed by the addition of methylzinc chloride (2.0 mol/l, 0.23 ml, 0.45 mmol). The reaction mixture was heated at reflux for 2 hours then allowed to cool to room temperature. Upon cooling, the reaction mixture was diluted with saturated ammonium chloride solution and extracted with ethyl acetate. The organics were filtered through Celite, dried over anhydrous magnesium sulphate and concentrated under reduced pressure. The residue was purified using column flash column chromatography eluting with ethyl acetate in iso-hex an e, to give 2-[3-(4,5-dihydroisoxazol-3-yl)-2-methyl-4-methylsulfonyl-phenyl]-4-methoxy-5-methyl-pyridazin-3-one (0.123 g) as a yellow solid.

1H NMR (CDCl₃):

8.1 (1H, d), 7.7 (1H, s), 7.6 (1H, d), 4.6 (2H, t), 4.2 (3H, s), 3.4 (2H, br), 3.2 (3H, s) 2.2 (3H, s), 2.1 (3H, s)

5-bromo-2-[3-(4,5-dihydroisoxazol-3-yl)-2-methyl-4-methylsulfonyl-phenyl]-4-methoxy-pyridazin-3-one prepared as described above in example 1.

### Step 2

### 2-[3-(4,5-dihydroisoxazol-3-yl)-2-methyl-4-methylsulfonyl-phenyl]-4-hydroxy-5-methyl-pyridazin-3-one

A mixture of 2-[3-(4,5-dihydroisoxazol-3-yl)-2-methyl-4-methylsulfonyl-phenyl]-4-methoxy-5-methyl-pyridazin-3-one.

2-[3-(4,5-dihydroisoxazol-3-yl)-2-methyl-4-methylsulfonyl-phenyl]-4-methoxy-5-methyl-pyridazin-3-one (0.12 g, 0.33 mmol) and sodium hydroxide monohydrate (3 mol/l, 2 ml, 6 mmol,) and refluxed for 3 hours under an atmosphere of nitrogen. The reaction was then allowed to cool to room temperature. The resulting residue was washed with diethyl ether (15 ml) and water. The aqueous layer was slowly acidified using concentrated hydrochloric acid until the product precipitated and the solution was acidic (pH 5). The product was dried in a vacuum oven overnight to leave 2-[3-(4,5-dihydroisoxazol-3-yl)-2-methyl-4-methylsulfonyl-phenyl]-4-hydroxy-5-methyl-pyridazin-3-one (0.09 g) as a pale yellow solid.

### Example 4

### 5-chloro-2-[2-chloro-4-(trifluoromethyl)phenyl]-4-hydroxy-pyridazin-3-one

### Step 1

### 4,5-dichloro-2-[2-chloro-4-(trifluoromethyl)phenyl]pyridazin-3-one

To a suspension of [2-chloro-4-(trifluoromethyl)phenyl]hydrazine (0.5 g, 2.37 mmol) in 4M hydrochloric acid (6 ml) was added 3,4-dichloro-2-hydroxy-2H-furan-5-one (0.4 g, 2.37 mmol) at 25° C. The mixture was heated under microwave irradiation at 140° C. for 2 hours, and then allowed to cool to room temperature. The reaction mixture was diluted with ethyl acetate and washed with water. The organic extracts were dried over magnesium sulphate and evaporated, then purified by reverse phase HPLC to give 4,5-dichloro-2-[2-chloro-4-(trifluoromethyl)phenyl]pyridazin-3-one as a yellow solid (135 mg).

1H NMR (CDCl₃):

7.95 (1H, s), 7.8 (1H, s), 7.7 (1H, d), 7.5 (1H, d)

3,4-dichloro-2-hydroxy-2H-furan-5-one (mucochloric acid) is commercially available. Aryl hydrazines such as [2-chloro-4-(trifluoromethyl)phenyl]hydrazine may be prepared according to literature procedures e.g. from the commercially available bromides as described in Tetrahedral Letters 40 (1999) 3543-3546 or from the aniline as described in Org. Synth. 1941, Coll. Vol. 1, 442.

### Step 2

### 5-chloro-2-[2-chloro-4-(trifluoromethyl)phenyl]-4-methoxy-pyridazin-3-one

A solution of sodium methoxide solution (30% in methanol, 5.4M, 0.07 ml, 0.42 mmol) was added drop wise over 5 minutes to a stirred solution of 4,5-dichloro-2-[2-chloro-4-(trifluoromethyl)phenyl]pyridazin-3-one (135 mg, 0.39 mmol) in dioxane (1.9 ml) at room temperature under an atmosphere of nitrogen. The resulting mixture was stirred at room temperature for a further hour, and then poured into a mixture of water (25 ml) and dichloromethane (25 ml). The organic layer was separated and the aqueous layer extracted with dichloromethane (2×25 ml). The combined organic extracts were washed with water, then brine, dried over magnesium sulphate and concentrated under reduced pressure, to give 5-chloro-2-[2-chloro-4-(trifluoromethyl)phenyl]-4-methoxy-pyridazin-3-one as the major product together with some of the isomeric 4-chloro-2-[2-chloro-4-(trifluoromethyl)phenyl]-5-methoxy-pyridazin-3-one as an orange solid (107 mg). This was used directly without further purification.

1H NMR (CDCl₃):

7.9 (1H, s), 7.8 (1H, s), 7.7 (1H, d), 7.5 (1H, d), 4.2 (3H, s)

### Step 3

### 5-chloro-2-[2-chloro-4-(trifluoromethyl)phenyl]-4-hydroxy-pyridazin-3-one

A mixture of 5-chloro-2-[2-chloro-4-(trifluoromethyl)phenyl]-4-methoxy-pyridazin-3-one and 4-chloro-2-[2-chloro-4-(trifluoromethyl)phenyl]-5-methoxy-pyridazin-3-one (107 mg, 0.277 mmol) and morpholine (2.5 ml) was heated at 100° C. for 3 hours under an atmosphere of nitrogen. The reaction mixture was allowed to cool to room temperature and then evaporated under reduced pressure. The resulting residue was dissolved in ethyl acetate (15 ml) and washed with 2M hydrochloric acid (3×15 ml) and brine (15 ml). The organic extract was dried over magnesium sulphate and purified by reverse phase HPLC to give 5-chloro-2-[2-chloro-4-(trifluoromethyl)phenyl]-4-hydroxy-pyridazin-3-one as a white solid (35 mg) along with its isomer 4-chloro-2-[2-chloro-4-(trifluoromethyl)phenyl]-5-hydroxy-pyridazin-3-one as a white solid (10 mg).

1H NMR (CDCl₃):

5-chloro-2-[2-chloro-4-(trifluoromethyl)phenyl]-4-hydroxy-pyridazin-3-one: 7.9 (1H, s), 7.8 (1H, s), 7.7 (1H, d), 7.6 (1H, d)

4-chloro-2-[2-chloro-4-(trifluoromethyl)phenyl]-5-hydroxy-pyridazin-3-one: 7.9 (1H, s), 7.8 (1H, s), 7.7 (1H, d), 7.6 (1H, d)

### Example 5

### 4-Isopropenyl-1-[2-methylsulfonyl-4-(trifluoromethyl)phenyl]-4H-pyridazine-5,6-dione

### Step 1

### Tert-butyl N-[2-methylsulfonyl-4-(trifluoromethyl)anilino]carbamate

To a stirred mixture of 1-bromo-2-methylsulfonyl-4-(trifluoromethyl)benzene (13.2 mmol, 4.00 g), tert-butyl carbazate (26.4 mmol, 3.56 g), Cs₂CO₃ (13.2 mmol, 4.34 g) and Pd(dppf)Cl₂. Dichloromethane adduct (2.64 mmol, 2.20 g) under a nitrogen atmosphere was added degassed toluene (27 ml). Nitrogen was bubbled through the reaction mixture for 15 min before stirring at 105° C. under an atmosphere of nitrogen. The reaction mixture was heated for 2 hr, then cooled, diluted with dichloromethane (50 ml), and the residue in the reaction flask was scratched out with more dichloromethane. The combined organic layers were filtered, washed through with fresh dichloromethane till washings clear and concentrated under reduced pressure to give a red brown oil. Using a volume of 200 ml silica slurried in a glass column with 1:1/Et₂O:isohexane as solvent, the crude material was taken up in a minimum of dichloromethane, added to the silica and eluted with the same solvent. Fractions containing the desired product were collected, giving 2.95 g of a sticky pale yellow solid which was tritrated with isohexane, filtered and air dried to give tert-butyl N-[2-methylsulfonyl-4-(trifluoromethyl)anilino]carbamate as a pale brown solid (2.63 g).

1H NMR (CDCl₃): δ8.07 (1H, s), 7.95 (1H, brs), 7.72 (1H, d), 7.22 (1H, d), 6.45 (1H, brs), 3.20 (3H, brs), 1.50 (9H, s)

### Step 2

### 2,3-dibromo-4-[[2-methylsulfonyl-4-(trifluoromethyl)phenyl]hydrazono]but-2-enoic acid

To tert-butyl N-[2-methylsulfonyl-4-(trifluoromethyl)anilino]carbamate (5.28 mmol, 1.87 g) was added 4M aqueous hydrochloric acid (20 ml). The reaction was stirred at 110° C. for 30 min, cooled to 70° C. and mucobromic acid (5.28 mmol, 1.39 g) was added in one portion. An immediate yellow precipitate formed; the reaction mixture was stirred at this temperature for 2 hr then hot filtered, washing out the flask with 25 ml hot water. The resulting yellow solid was taken up in ethyl acetate, dried over magnesium sulphate, filtered and concentrated under reduced pressure giving (Z,4Z)-2,3-dibromo-4-[[2-methylsulfonyl-4-(trifluoromethyl)phenyl]hydrazono]but-2-enoic acid as a yellow solid (2.44 g).

1H NMR (CDCl₃+drop d6DMSO): δ10.30 (1H, s), 8.59 (1H, s), 8.05 (1H, s), 7.93 (1H, d), 7.79 (1H, d), 3.12 (3H, s)

### Step 3

### 4,5-dibromo-2-[2-methylsulfonyl-4-(trifluoromethyl)phenyl]pyridazin-3-one

To a stirred solution of (Z,4Z)-2,3-dibromo-4-[[2-methylsulfonyl-4-(trifluoromethyl)phenyl]hydrazono]but-2-enoic acid (1.65 g, 1.00 equiv) in tetrahydrofuran (30 ml) at room temperature, was added 1,1′-carbonyldiimidazole (0.614 g) in one portion. The reaction mixture was then stirred at 50° C. for 1 hour then cooled, and concentrated under reduced pressure to give a purple oil. This oil was taken up in the minimum of dichloromethane and added to a 10 g isolute cartridge, eluting with dichloromethane. The fractions containing the desired product were combined and concentrated under reduced pressure to give 4,5-dibromo-2-[2-methylsulfonyl-4-(trifluoromethyl)phenyl]pyridazin-3-one as an off white solid (1.12 g).

1H NMR (CDCl₃): δ8.12 (1H, s), 7.93 (1H, s), 7.75 (1H, d), 7.40 (1H, d), 3.20 (3H, s)

### Step 4

### 5-bromo-4-methoxy-2-[2-methylsulfonyl-4-(trifluoromethyl)phenyl]pyridazin-3-one

To 1,4-dioxane (15 ml) was added under nitrogen 4,5-dibromo-2-[2-methylsulfonyl-4-(trifluoromethyl)phenyl]pyridazin-3-one (1.35 g). The mixture was stirred at room temperature as a solution of sodium methoxide (3.06 mmol, 0.169 g, 1.08 equiv) (0.55 mls of 30% sodium methoxide in methanol in 4.8 ml methanol and 7.2 ml 1,4-dioxane) was added via syringe pump over 3.25 hr and then stirred for a further 1 hr at room temperature. The reaction mixture was poured into water (25 ml) and extracted with ethyl acetate (2×20 ml); the organic extracts were combined and washed with water and saturated brine before drying over magnesium sulphate, then filtered and concentrated under reduced pressure to give the crude product as a thick orange oil (1.33 g). This oil was purified by column chromatography on silica, and eluting with a gradient of hexane/ethyl acetate to give 5-bromo-4-methoxy-2-[2-methylsulfonyl-4-(trifluoromethyl)phenyl]pyridazin-3-one (0.780 g) and also the isomeric 4-bromo-5-methoxy-2-[2-methylsulfonyl-4-(trifluoromethyl)phenyl]pyridazin-3-one (0.307 g) as cream solids.

1H NMR (CDCl₃):

5-bromo-4-methoxy-2-[2-methylsulfonyl-4-(trifluoromethyl)phenyl]pyridazin-3-one: δ8.42 (1H, brs), 8.07 (1H, dd), 7.96 (1H, s), 7.64 (1H, d), 4.30 (3H, s), 3.24 (3H, s)

4-bromo-5-methoxy-2-[2-methylsulfonyl-4-(trifluoromethyl)phenyl]pyridazin-3-one: δ8.40 (1H, brs), 8.05 (1H, dd), 7.90 (1H, s), 7.60 (1H, d), 4.17 (3H, s), 3.25 (3H, s)

### Step 5

### 5-isopropenyl-4-methoxy-2-[2-methylsulfonyl-4-(trifluoromethyl)phenyl]pyridazin-3-one

Nitrogen was bubbled through 1,2-dimethoxyethane (8 ml) for 15 minutes before adding to a mixture of 5-bromo-4-methoxy-2-[2-methylsulfonyl-4-(trifluoromethyl)phenyl]pyridazin-3-one (0.65 g), caesium fluoride (0.46 g), isopropenylboronic acid pinacol ester (0.27 g) and [1,1′-bis(diphenylphosphino)ferrocene]palladium(II)dichloride dichloromethane adduct (0.13 g) in a 20 ml microwave vial. The mixture was gently stirred as nitrogen was bubbled through for a further 5 minutes, before capping the vial. The mixture was microwaved for 30 min at 150° C. then allowed to cool and filtered and washed through with ethyl acetate. The filtrate was concentrated under reduced pressure giving a thick red-brown oil which was purified by column chromatography on silica, loading in a minimum of dichloromethane and eluting with a gradient of isohexane/ethyl acetate. Fractions containing the desired product were concentrated under reduced pressure to give 5-isopropenyl-4-methoxy-2-[2-methylsulfonyl-4-(trifluoromethyl)phenyl]pyridazin-3-one as a thick brown oil (0.290 g).

1H NMR (CDCl₃): δ8.40 (1H, s), 8.04 (1H, d), 7.80 (1H, s), 7.66 (1H, d), 5.40 (1H, m), 5.34 (1H, m), 4.17 (3H, s), 3.28 (3H, s), 2.17 (3H, s)

### Step 6

### 4-isopropenyl-1-[2-methylsulfonyl-4-(trifluoromethyl)phenyl]-4H-pyridazine-5,6-dione

5-isopropenyl-4-methoxy-2-[2-methylsulfonyl-4-(trifluoromethyl)phenyl]pyridazin-3-one (0.232 g) in morpholine (0.520 g) was stirred at 100° C. for 45 min. The reaction mixture was cooled, and excess morpholine removed under high vacuum. The resulting residue was taken up in dichloromethane, washed quickly with 1M aqueous hydrochloric acid and passed through a phase separator. The filtrate was concentrated under reduced pressure to give the crude product as a pale brown solid (170 mg). This crude material was taken up in a minimum of dichloromethane and purified by column chromatography on silica eluting with ethyl acetate. Fractions containing the desired product were combined and concentrated under reduced pressure to give 4-isopropenyl-1-[2-methylsulfonyl-4-(trifluoromethyl)phenyl]-4H-pyridazine-5,6-dione as a pink solid (0.085 g).

1H NMR (CDCl₃): δ8.45 (1H, brs), 8.05 (1H, d), 7.91 (1H, s), 7.66 (1H, d), 5.63 (1H, brs), 5.49 (1H, brs), 3.25 (3H, s). Melting point: 144° C.-147° C.

TABLE C1
Examples of herbicidal compounds of the present invention.

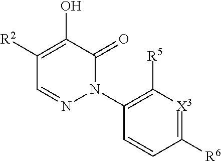

| CMP | R² | X³ | R⁵ | R⁶ | R⁹ | NMR |
|---|---|---|---|---|---|---|
| 1.001 | —Cl | CR⁹ | —Cl | —Cl | H | 7.9 (1H, s), 7.6 (1H, s), |
| | | | | | | 7.4 (1H, d), 7.3 (1H, d) |
| 1.002 | —Cl | CR⁹ | —Cl | —CF₃ | H | 7.9 (1H, s), 7.8 (1H, s), |
| | | | | | | 7.7 (1H, d), 7.6 (1H, d) |
| 1.003 | —Cl | CR⁹ | —S(O)₂Me | —CF₃ | H | 8.4 (1H, d), 8.1 (1H, d), |
| | | | | | | 7.9 (1H, s), 7.6 (1H, s), |
| | | | | | | 3.2 (3H, s) |
| 1.004 | —Cl | CR⁹ | —CH₃ | S(O)₂Me | 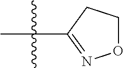 [SMILES: *C1=NOCC1] | 8.1 (1H, d), 7.9 (1H, s), 7.6 (1H, d), 4.6 (2H, t), 3.4 (2H, br), 3.2 (3H, s), 2.1 (3H, s) |
| 1.005 | —Et | CR⁹ | —CH₃ | S(O)₂Me | 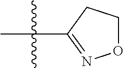 [SMILES: *C1=NOCC1] | 8.3 (1H, d), 7.9 (1H, s), 7.6 (1H, d), 4.6 (2H, t), 3.3 (2H, br), 3.2 (3H, s), 2.7 (2H, q), 2.1 (3H, s), 1.3 (3H, t) |
| 1.006 | -vinyl | CR⁹ | —CH₃ | S(O)₂Me | 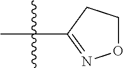 [SMILES: *C1=NOCC1] | 8.1 (1H, d), 8.0 (1H, s), 7.6 (1H, d), 6.8 (1H, dd), 6.1 (1H, d), 5.7 (1H, d), 4.6 (2H, t), 3.4 (2H, tr), 3.2 (3H, s), 2.1 (3H, s) |
| 1.007 | —CH(CH₃)═CH₂ | CR⁹ | —CH₃ | S(O)₂Me | 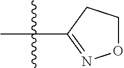 [SMILES: *C1=NOCC1] | 8.2 (1H, d), 7.9 (1H, s), 7.7 (1H, d), 5.6 (1H, s), 5.5 (1H, s), 4.6 (2H, tr), 3.4 (2H, tr), 3.2 (3H, s), 2.2 (3H, s), 2.1 (3H, s) |
| 1.008 | H | CR⁹ | —CH₃ | S(O)₂Me | 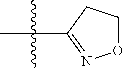 [SMILES: *C1=NOCC1] | 8.1 (1H, d), 7.9 (1H, d), 7.6 (1H, d), 6.8 (1H, d), 4.6 (2H, t), 3.3 (2H, br), 3.2 (3H, s), 2.1 (3H, s) |
| 1.009 | —CN | CR⁹ | —CH₃ | S(O)₂Me | 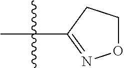 [SMILES: *C1=NOCC1] | 8.1 (1H, d), 7.8 (1H, s), 7.6 (1H, d), 4.5 (2H, t), 3.4 (2H, t), 3.2 (3H, s), 2.2 (3H, s) |
| 1.010 | -iPr | CR⁹ | —CH₃ | S(O)₂Me | 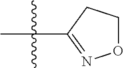 [SMILES: *C1=NOCC1] | 8.1 (1H, d), 7.9 (1H, s), 7.6 (1H, d), 4.6 (2H, t), 3.4 (2H, br), 3.2 (3H, s), 3.2 (1H, m), 2.2 (3H, s), 2.1 (3H, s), 1.3 (6H, d) |
| 1.011 | —S(O)₂CH₃ | CR⁹ | —CH₃ | S(O)₂Me | 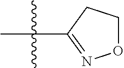 [SMILES: *C1=NOCC1] | 8.23 (1 H, s), 8.14 (1 H, d), 7.60 (1 H, d), 4.54-4.67m), (2 H, m), 3.43-3.31 (2 H, m), 3.35 (3H, s) 3.23 (3 H, s), 2.15 (3 H, s) |
| 1.012 | —Br | CR⁹ | —S—CH₃ | CF₃ | H | 8.04 (1 H, br. s.) 7.74 |
| | | | | | | (1 H, s) 7.62 (1 H, d) |
| | | | | | | 7.55 (1 H, d) 2.51 (3 H, s) |
| 1.013 | —Br | CR⁹ | —CH₃ | —S(O)₂Me | 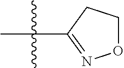 [SMILES: *C1=NOCC1] | 8.1 (1H, d), 7.9 (1H, s), 7.6 (1H, d), 4.6 (2H, t), 3.4 (2H, br), 3.2 (3H, s), 2.1 (3H, s) |
| 1.014 | —O—CH₃ | CR⁹ | —CF₃ | —CF₃ | H | 7.9 (1H, s), 7.8 (1H, s), |
| | | | | | | 7.7 (1H, d), 7.6 (1H, d), |
| | | | | | | 4.2 (3H, s) |
| 1.015 | —Cl | CR⁹ | —CF₃ | —CF₃ | H | 7.9 (1H, s), 7.8 (1H, s), |
| | | | | | | 7.7 (1H, d), 7.6 (1H, d) |
| 1.016 | —CH₃ | CR⁹ | —CH₃ | —S(O)₂Me | 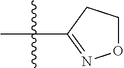 [SMILES: *C1=NOCC1] | 8.1 (1H, d), 7.9 (1H, s), 7.6 (1H, d), 4.6 (2H, t), 3.4 (2H, br), 3.2 (3H, s), 3.2 (3H, s), 2.1 (3H, s) |
| 1.017 | —Cl | CR⁹ | —Cl | —S(O)₂Me | 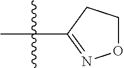 [SMILES: *C1=NOCC1] | 8.2 (1H, d), 7.9 (1H, s), 7.7 (1H, d), 4.6 (2H, t), 3.4 (2H, tr), 3.2 (3H, s) |
| 1.018 | —S—CH₃ | CR⁹ | —CH₃ | —S(O)₂Me | 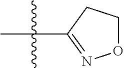 [SMILES: *C1=NOCC1] | 8.14 (1 H, d), 7.85 (1 H, s), 7.57 (1 H, d), 4.60 (2 H, t), 3.29- 3.48 (2 H, m), 3.22 (3 H, s), 2.63 (3 H, s), 2.12 (3 H, s) |
| 1.019 | —Cl | N | —CH₃ | —CF₃ | — | 7.9 (1H, s), 7.8 (1H, d), |
| | | | | | | 7.7 (1H, d), 2.5 (s, 3H) |
| 1.020 | —CH₃ | N | —CH₃ | —CF₃ | — | 7.78, 1H, d; 7.68, 1H, |
| | | | | | | d; 2.48 (3H, s); 1.57 |
| | | | | | | (3H, s) |
| 1.021 | -vinyl | N | —CH₃ | —CF₃ | — | 8.05 (1H, s), 7.82 (1H, |
| | | | | | | d), 7.68 (1H, d), 6.79 |
| | | | | | | (1H, dd), 6.06 (1H, d), |
| | | | | | | 5.67 (1H, d), 2.48 (3H, s) |
| 1.022 | -ethyl | N | —CH₃ | —CF₃ | — | 7.81 (2H, m), |
| | | | | | | 7.68 (1H, d), |
| | | | | | | 2.65 (2H, q), 2.49 (3H, s), |
| | | | | | | 1.30 (3H, t) |
| 1.023 | —Br | N | —CH₃ | —CF₃ | — | 8.01 (1 H, s), 7.80 (1 H, |
| | | | | | | d), 7.70 (1 H, d), |
| | | | | | | 2.48 (3 H, s) |
| 1.024 | —CH(CH₃)═CH₂ | N | —CH₃ | —CF₃ | — | 8.03 (1 H, d) 7.99 (1 H, |
| | | | | | | s) 7.84 (1 H, d) 5.55 (1 H, |
| | | | | | | s) 5.44 (1 H, t) 2.45 |
| | | | | | | (3 H, s) 2.20-2.24 |
| | | | | | | (3 H, m) 652 |
| 1.025 | —S—CH₃ | N | —CH₃ | —CF₃ | — | 7.86 (1 H, s), 7.81 (1 H, |
| | | | | | | d), 7.68 (1 H, d), |
| | | | | | | 2.63 (3 H, s), 2.49 |
| | | | | | | (3 H, s) |
| 1.026 | —CN | CR⁹ | —CH₃ | —S(O)₂Me | 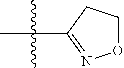 [SMILES: *C1=NOCC1] | |
| 1.027 | H | N | —CH₃ | —CF₃ | — | 7.91 (2H, d), |
| | | | | | | 7.82 (1H, d), 7.70 |
| | | | | | | (1H, d), 6.78 (1H, d), |
| | | | | | | 2.48 (3H, s) |
| | | | | | | (TFA Salt) |
| 1.028 | H | N | —CH₃ | —CF₃ | — | |
| 1.029 | —S(O)₂Me | N | —CH₃ | —CF₃ | — | 8.31 (1 H, s), 7.84 (1 H, |
| | | | | | | d) , 7.70 (1 H, d), |
| | | | | | | 3.35 (3 H, s), 2.50 |
| | | | | | | (3 H, s) |
| 1.030 | —S(O)Me | N | —CH₃ | —CF₃ | —S(O)₂Me | 8.25 (1 H, s), 7.87 (1 H, |
| | | | | | | d), 7.73 (1 H, d), |
| | | | | | | 3.01 (3 H, s), 2.49 |
| | | | | | | (3 H, s) |
| 1.031 | -cPr | CR⁹ | —S(O)₂Me | —CF₃ | H | 0.96-1.03 (2 H, m) |
| | | | | | | 1.09-1.17 (2 H, m) |
| | | | | | | 1.97-2.08 (1 H, m) |
| | | | | | | 3.25 (3 H, s) 7.48 (1 H, |
| | | | | | | s) 7.62-7.66 (1 H, m) |
| | | | | | | 8.02-8.06 (1 H, m) |
| | | | | | | 8.41-8.44 (1 H, m) |
| 1.032 | —Br | CR⁹ | —S(O)₂Me | —CF₃ | H | 8.44 (1 H, d), 8.03- |
| | | | | | | 8.12 (1 H, m), 7.98 (1 H, |
| | | | | | | s), 7.65 (1 H, d), |
| | | | | | | 3.24 (3 H, s) |
| 1.033 | H | CR⁹ | —S(O)₂Me | —CF₃ | H | 8.44 (1 H, d), 8.06 (1 H, |
| | | | | | | dd), 7.86 (1 H, d), |
| | | | | | | 7.67 (1 H, d), 6.74 |
| | | | | | | (1 H, d), 3.24 (3 H, s) |
| 1.034 | —S—CH₃ | CR⁹ | —S(O)₂Me | —CF₃ | H | 8.43 (1 H, d), 8.05 (1 H, |
| | | | | | | dd), 7.83 (1 H, s), |
| | | | | | | 7.65 (1 H, d), 3.26 |
| | | | | | | (3 H, s), 2.61 (3 H, s) |
| 1.035 | H | N | —S(O)₂Me | —CF₃ | — | 3.84 (3 H, s) 6.73 (1 H, |
| | | | | | | d, J = 4.8 Hz) 7.89 (1 H, |
| | | | | | | d, J = 4.8 Hz) 8.34 (1 H, |
| | | | | | | d, J = 8.6 Hz) 8.41- |
| | | | | | | 8.45 (1 H, m) |
| 1.036 | -ethyl | N | —S(O)₂Me | —CF₃ | — | 1.28 (3 H, t, J = 7.8 Hz) |
| | | | | | | 2.63 (2 H, q, J = 7.5 Hz) |
| | | | | | | 3.35 (3 H, s) 7.23 (1 H, |
| | | | | | | br. s.) 7.83 (1 H, s) |
| | | | | | | 8.07 (1 H, d, J = 8.1 Hz) |
| | | | | | | 8.16 (1 H, d, J = 7.5 Hz) |
| 1.037 | -ethyl | CR⁹ | —S(O)₂Me | —Cl | H | 8.16 (1H, s), |
| | | | | | | 7.75 (2H, m), |
| | | | | | | 7.45 (1H, d), |
| | | | | | | 3.21 (3H, s), 2.63 (2H, q), |
| | | | | | | 1.30 (3H, t) |
| 1.038 | -ethyl | CR⁹ | —S(O)₂Me | -ethyl | H | 8.16 (1H, s), 7.75 (2H, m), |
| | | | | | | 7.45 (1H, d), 3.21 (3H, s), |
| | | | | | | 2.63 (2H, q), 1.30 (3H, t) |
| 1.039 | —CH(CH₃)═CH₂ | CR⁹ | —S(O)₂Me | —CF₃ | H | 8.45 (1H, brs), |
| | | | | | | 8.05 (1H, d), 7.91 (1H, s), |
| | | | | | | 7.66 (1H, d), |
| | | | | | | 5.63 (1H, brs), |
| | | | | | | 5.49 (1H, brs), |
| | | | | | | 3.25 (3H, s) |
| 1.040 | H | CR⁹ | —S(O)₂Me | —Cl | H | 8.15 (1H, brs), |
| | | | | | | 7.80 (1H, d), |
| | | | | | | 7.74 (1H, d), |
| | | | | | | 7.47 (1H, d), |
| | | | | | | 6.69 (1H, d), 3.21 (3H, s), |
| | | | | | | 2.23 (3H, s) |
| 1.041 | —S(O)Me | CR⁹ | —S(O)₂Me | —CF₃ | H | 8.38 (1 H, s), 8.13 |
| | | | | | | (1 H, s), 8.05 (1 H, d), |
| | | | | | | 7.67 (1 H, d), 3.21 |
| | | | | | | (3 H, s), 2.95 (3 H, s) |
| 1.042 | —S(O)₂Me | CR⁹ | —S(O)₂Me | —CF₃ | H | 8.43 (1 H, s), 8.23 (1 H, |
| | | | | | | br. s.), 8.08 (1 H, d), |
| | | | | | | 7.66 (1 H, d), 3.30 (3 H, |
| | | | | | | br. s.), 3.23 (3 H, s) |
| 1.043 | —S(O)Me | CR⁹ | —CH₃ | —S(O)₂Me | 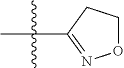 [SMILES: *C1=NOCC1] | 8.25 (1 H, s), 8.15 (1 H, d), 7.60 (1 H, d), 4.60 (2 H, m), 3.35- 3.45 (2 H, m), 3.23 3 H, s), 3.01 (3 H, s), 2.13 (3 H, s) |
| 1.044 | CH₃C(O)NHC(CH₃)₂CH₂— | CR⁹ | —S(O)₂Me | —CF₃ | H | 8.29 (1 H, s) 7.97 (1 H, |
| | | | | | | d) 7.61 (1 H, d) 7.54 |
| | | | | | | (1 H, s) 3.15 (3 H, s) 2.94 |
| | | | | | | (2 H, s) 1.80 (3 H, s) |
| | | | | | | 1.28 (6 H, s) |
| 1.045 | -ethyl | CR⁹ | —S(O)₂Me | —CF₃ | H | 8.39-8.47 (1 H, m) |
| | | | | | | 8.00-8.10 (1 H, m) |
| | | | | | | 7.81 (1 H, s) 7.65 (1 H, |
| | | | | | | d) 3.24 (3 H, s) 2.63 |
| | | | | | | (2 H, q) 1.28 (3 H, t) |
| 1.046 | —NH₂ | CR⁹ | —S(O)₂Me | —CF₃ | H | 8.05 (1 H, d), 7.66 |
| | | | | | | (1 H, s), 7.50 (1H, d), |
| | | | | | | 4.51 (2 H, t), 3.37 (2 H, |
| | | | | | | br. s.), 3.14 (3 H, s), |
| | | | | | | 2.02 (3 H, s) |
| 1.047 | —S(O)₂Me | CR⁹ | —S(O)₂Me | —Cl | H | 8.23 (1 H, s), 8.14 (1 H, |
| | | | | | | s), 7.77 (1 H, d), |
| | | | | | | 7.43 (1 H, d), 6.23 |
| | | | | | | (1 H, br.s), 3.29 (3 H, s), |
| | | | | | | 3.18 (3 H, s) |
| 1.048 | —S—CH₃ | CR⁹ | —S(O)₂Me | —Cl | H | 8.14 (1 H, s), 7.78 (1 H, |
| | | | | | | s), 7.73 (1 H, dd), |
| | | | | | | 7.44 (1 H, d), 3.22 |
| | | | | | | (3 H, s), 2.58 (3 H, s) |
| 1.049 | CH₃OCH₂CH₂OCH₂— | CR⁹ | —S(O)₂Me | —CF₃ | H | 8.44 (1 H, s) 8.03- |
| | | | | | | 8.08 (2 H, m) 7.65 (1 H, |
| | | | | | | d) 4.63 (2 H, s) 3.72- |
| | | | | | | 3.77 (2 H, m) 3.60- |
| | | | | | | 3.65 (2 H, m) 3.42 |
| | | | | | | (3 H, s) 3.25 (3 H, s) |
| 1.050 | (CH₃)₂C═CH— | CR⁹ | —S(O)₂Me | —CF₃ | H | 8.44 (1 H, d) 8.05 (1 H, |
| | | | | | | d) 7.84 (1 H, s) 7.69 |
| | | | | | | (1 H, d) 6.08 (1 H, d) |
| | | | | | | 3.26 (3 H, s) 1.99 (3 H, |
| | | | | | | d) 1.88 (3 H, d) |
| 1.051 | 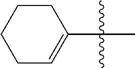 [SMILES: *C1=CCCCC1] | CR⁹ | —S(O)₂Me | —CF₃ | H | 8.45 (1 H, s) 8.22 (1 H, d) 7.90 (1 H, s) 7.84 (1 H, d) 6.27 (1 H, t) 2.48 (2 H, br. s.) 2.24-2.33 (2 H, m) 1.77-1.84 (2 H, m) 1.68-1.77 (2 H, m) |
| 1.052 | —NH₂ | N | —CF₃ | —CH₃ | — | 7.78 (1 H, d), 7.69 (1 H, |
| | | | | | | s), 7.65 (1 H, d), |
| | | | | | | 4.14-4.21 (2 H, br. s), |
| | | | | | | 2.47 (3 H, s) |
| 1.053 | -vinyl | CR⁹ | —S(O)₂M | —CF₃ | H | 8.44 (1 H, br. s.) 8.05 |
| | | | | | | (1 H, d) 8.01 (1 H, s) |
| | | | | | | 7.66 (1 H, d) 6.77 (1 H, |
| | | | | | | dd) 6.06 (1 H, d) 5.68 |
| | | | | | | (1 H, d) 3.25 (3 H, s) |

TABLE C2
Examples of herbicidal compounds of the present invention.

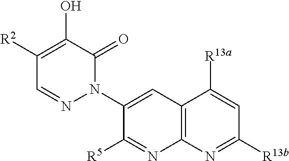

| Compound | R² | R⁵ | R^{13a} | R^{13b} |
|---|---|---|---|---|
| 2.001 | Ethyl | —CF₃ | H | H |
| 2.002 | Methyl | —CF₃ | Methyl | Methyl |

TABLE C3
Examples of herbicidal compounds of the present invention.

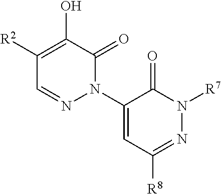

| Compound | R² | R⁸ | R⁷ |
|---|---|---|---|
| 3.001 | Methyl | Methyl | -phenyl |
| 3.002 | Methyl | Methyl | 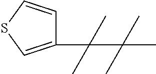 |
| 3.003 | Methyl | Methyl | n-butyl |

TABLE C4
Examples of herbicidal compounds of the present invention.

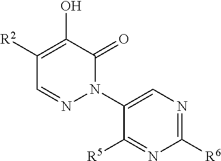

| Compound | R² | R⁵ | R⁶ |
|---|---|---|---|
| 4.001 | Methyl | 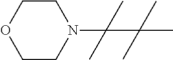 | —CF₃ |

TABLE C5
Examples of herbicidal compounds of the present invention.

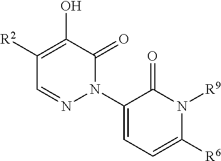

| Compound | R² | R⁶ | R⁹ |
|---|---|---|---|
| 5.001 | —CH₃ | —CF₃ | 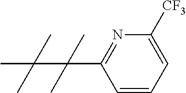 |
| 5.002 | —CH₃ | H | CH₂═CH—CH₂— |
| 5.003 | —CH₃ | H | Methyl |
| 5.004 | —CH₃ | H | 4-MeO-benzyl- |
| 5.005 | —CH₃ | H | CF₃CH₂— |
| 5.006 | —CH₃ | H | cPr-CH₂— |
| 5.007 | —CH₃ | H | CH₃C(═CH₂)—CH₂— |
| 5.008 | —CH₃ | H | Benzyl- |
| 5.009 | —CH₃ | H | CH₃OCH₂CH₂— |
| 5.010 | —CH₃ | —CF₃ | Me |
| 5.011 | —CH₃ | —CF₃ | CH₂═CHCH₂— |
| 5.012 | —CH₃ | H | 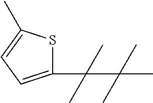 |
| 5.013 | —CH₃ | H | 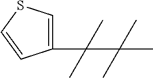 |
| 5.014 | —CH₃ | H | 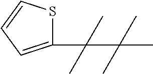 |
| 5.015 | —CH₃ | H | 3C1, 4-F-phenyl- |
| 5.016 | —CH₃ | H | 4-MeO-phenyl- |
| 5.017 | —CH₃ | H | 4-Me-phenyl |
| 5.018 | —CH₃ | H | Phenyl- |
| 5.019 | —CH₃ | H | 3-F,4-Me-phenyl- |
| 5.020 | —CH₃ | H | 2-Cl,4-Me-phenyl- |
| 5.021 | —CH₃ | H | 3-CN-phenyl- |
| 5.022 | —CH₃ | H | 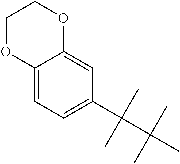 |
| 5.023 | —CH₃ | H | 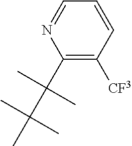 |
| 5.024 | —CH₃ | H | 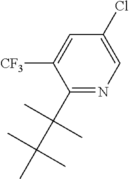 |
| 5.025 | —CH₃ | H | 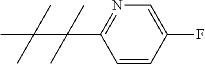 |
| 5.026 | —CH₃ | H | 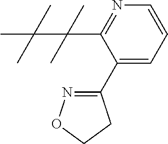 |
| 5.027 | —CH₃ | H | 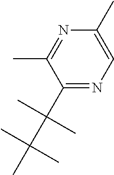 |

TABLE C6
Examples of herbicidal compounds of the present invention.

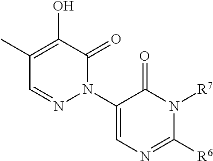

| Compound | R⁶ | R⁷ |
|---|---|---|
| 6.001 | H | —CH₂CH═CH₂ |
| 6.002 | 3-Cl-phenyl- | nPr |
| 6.003 | 3-F-phenyl- | chexyl- |
| 6.004 | 3-F-phenyl- | 2-Me,5-Cl |
| | | phenyl- |
| 6.005 | c-propyl | n-butyl |

### Biological Examples

Seeds of a variety of test species are sown in standard soil in pots (Alopecurus myosuroides (ALOMY), Setaria faberi (SETFA), Echinochloa crus-galli (ECHCG), Solanum nigrum (SOLNI), Amaranthus retoflexus (AMARE), Ipomoea hederacea (IPOHE)). After cultivation for one day (pre-emergence) or after 8 days cultivation (post-emergence) under controlled conditions in a glasshouse (at 24/16° C., day/night; 14 hours light; 65% humidity), the plants are sprayed with an aqueous spray solution derived from the formulation of the technical active ingredient in acetone/water (50:50) solution containing 0.5% Tween 20 (polyoxyethelyene sorbitan monolaurate, CAS RN 9005-64-5). Compounds are applied at 1000 g/h. The test plants are then grown in a glasshouse under controlled conditions in a glasshouse (at 24/16° C., day/night; 14 hours light; 65% humidity) and watered twice daily. After 13 days for pre and post-emergence, the test is evaluated for the percentage damage caused to the plant. The biological activities are shown in the following table on a five point scale (5=80-100%; 4=60-79%; 3=40-59%; 2=20-39%; 1=0-19%).

| | POST Application | | | | | | PRE Application | | | | | |
|---|---|---|---|---|---|---|---|---|---|---|---|---|
| Compound | SOLNI | AMARE | SETFA | ALOMY | ECHCG | IPOHE | SOLNI | AMARE | SETFA | ALOMY | ECHCG | IPOHE |
| 1.001 | 5 | 5 | 5 | 1 | 5 | 5 | 3 | 4 | 4 | 2 | 4 | 1 |
| 1.002 | 5 | 5 | 5 | 1 | 5 | 5 | 5 | 5 | 4 | 2 | 5 | 4 |
| 1.003 | 5 | 5 | 5 | 5 | 5 | 5 | 5 | 5 | 5 | 5 | 5 | 5 |
| 1.004 | 5 | 5 | 5 | 5 | 5 | 5 | 5 | 5 | 5 | 5 | 5 | 5 |
| 1.005 | 5 | 5 | 5 | 5 | 5 | 5 | 5 | 5 | 2 | 4 | 4 | 4 |
| 1.006 | 5 | 5 | 5 | 4 | 5 | 5 | 5 | 5 | 4 | 1 | 5 | 4 |
| 1.007 | 5 | 5 | 5 | 5 | 5 | 5 | 4 | 5 | 3 | 3 | 5 | 5 |
| 1.008 | 5 | 5 | 5 | 5 | 5 | 5 | 5 | 5 | 5 | 2 | 5 | 5 |
| 1.009 | 5 | 5 | 5 | 1 | 5 | 5 | 4 | 5 | 4 | 1 | 5 | 4 |
| 1.010 | 5 | 5 | 5 | 5 | 5 | 5 | 1 | 5 | 2 | 3 | 3 | 1 |
| 1.011 | 5 | 5 | 5 | 5 | 5 | 5 | 5 | 5 | 5 | 5 | 5 | 5 |
| 1.013 | 5 | 5 | 5 | 5 | 5 | 5 | 5 | 5 | 5 | 4 | 5 | 4 |
| 1.014 | 5 | 5 | 4 | 1 | 1 | 3 | 1 | 1 | 1 | 1 | 1 | 1 |
| 1.015 | 5 | 5 | 5 | 5 | 5 | 5 | 5 | 5 | 1 | 1 | 2 | 4 |
| 1.016 | 5 | 5 | 5 | 5 | 5 | 5 | 5 | 5 | 5 | 5 | 5 | 4 |
| 1.017 | 5 | 5 | 5 | 5 | 5 | 5 | 5 | 5 | 5 | 5 | 5 | 5 |
| 1.018 | 5 | 5 | 2 | 2 | 2 | 5 | 5 | 5 | 2 | 2 | 2 | 5 |
| 1.019 | 5 | 5 | 5 | 5 | 5 | 5 | 5 | 5 | 5 | 5 | 5 | 5 |
| 1.020 | 5 | 5 | 5 | 3 | 5 | 5 | 5 | 5 | 5 | 3 | 5 | 5 |
| 1.021 | 5 | 5 | 5 | 3 | 5 | 5 | 5 | 5 | 5 | 3 | 5 | 5 |
| 1.022 | 5 | 5 | 4 | 4 | 5 | 4 | 5 | 5 | 4 | 4 | 5 | 4 |
| 1.023 | 5 | 5 | 5 | 3 | 5 | 5 | 5 | 5 | 5 | 3 | 5 | 5 |
| 1.024 | 5 | 5 | 5 | 5 | 5 | 5 | 5 | 5 | 5 | 5 | 5 | 5 |
| 1.025 | 5 | 5 | 5 | 2 | 5 | 5 | 5 | 5 | 5 | 2 | 5 | 5 |
| 1.026 | 5 | 5 | 5 | 1 | 5 | 5 | 5 | 5 | 5 | 1 | 5 | 5 |
| 1.027 | 5 | 4 | 4 | 1 | 5 | 5 | 5 | 4 | 4 | 1 | 5 | 5 |
| 1.029 | 4 | 3 | 4 | 1 | 4 | 2 | 4 | 3 | 4 | 1 | 4 | 2 |
| 1.030 | 5 | 4 | 5 | 2 | 5 | 3 | 5 | 4 | 5 | 2 | 5 | 3 |
| 1.031 | 5 | 5 | 5 | 5 | 5 | 5 | 5 | 5 | 5 | 5 | 5 | 5 |
| 1.032 | 5 | 5 | 5 | 5 | 5 | 5 | 5 | 5 | 5 | 5 | 5 | 5 |
| 1.033 | 5 | 5 | 4 | 5 | 5 | 5 | 5 | 5 | 4 | 5 | 5 | 5 |
| 1.034 | 5 | 5 | 3 | 1 | 4 | 4 | 5 | 5 | 3 | 1 | 4 | 4 |
| 1.035 | 5 | 5 | 5 | 2 | 5 | 5 | 5 | 5 | 5 | 2 | 5 | 5 |
| 1.036 | 5 | 5 | 5 | 5 | 5 | 5 | 5 | 5 | 5 | 5 | 5 | 5 |
| 1.037 | 5 | 5 | 5 | 5 | 5 | 4 | 5 | 5 | 5 | 5 | 5 | 4 |
| 1.038 | 5 | 5 | 5 | 4 | 5 | 5 | 5 | 5 | 5 | 4 | 5 | 5 |
| 1.039 | 5 | 5 | 5 | 5 | 5 | 5 | 5 | 5 | 5 | 5 | 5 | 5 |
| 1.040 | 5 | 5 | 3 | 2 | 5 | 5 | 5 | 5 | 3 | 2 | 5 | 5 |
| 1.041 | 5 | 5 | 2 | 1 | 4 | 4 | 5 | 5 | 2 | 1 | 4 | 4 |
| 1.042 | 2 | 2 | 1 | 1 | 1 | 1 | 2 | 2 | 1 | 1 | 1 | 1 |
| 1.043 | 4 | 5 | 3 | 1 | 3 | 3 | 4 | 5 | 3 | 1 | 3 | 3 |
| 1.044 | 4 | 5 | 2 | 1 | 5 | 4 | 4 | 5 | 2 | 1 | 5 | 4 |
| 1.045 | 5 | 5 | 5 | 5 | 5 | 5 | 5 | 5 | 5 | 5 | 5 | 5 |
| 1.047 | 2 | 2 | 1 | 1 | 1 | 2 | 2 | 2 | 1 | 1 | 1 | 2 |
| 1.048 | 4 | 4 | 2 | 1 | 3 | 3 | 4 | 4 | 2 | 1 | 3 | 3 |
| 1.053 | 5 | 5 | 5 | 4 | 5 | 5 | 5 | 5 | 5 | 4 | 5 | 5 |

1. A compound of Formula (I): 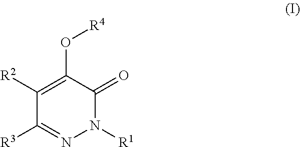
or an agronomically acceptable salt thereof,
wherein:—
R¹ is selected from the group consisting of A1 and A2 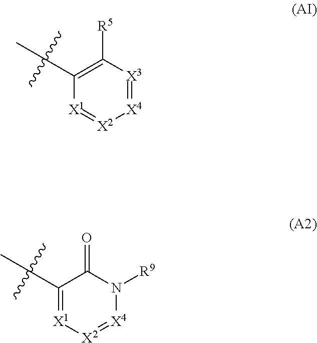
wherein
X¹ is N or CR⁷;
X² is N or CR⁸;
X³ is N or CR⁹;
X⁴ is N or CR⁶;
R² is selected from the group consisting of hydrogen, halogen, cyano, C₁-C₆alkyl, C₃-C₆cycloalkyl, C₂-C₆alkenyl, C₄-C₆cycloalkenyl, C₂-C₆alkynyl, C₁-C₆haloalkyl, C₁-C₆ alkoxy, C₁-C₆alkoxy-C₁-C₃-alkyl, C₁-C₆ alkoxy-C₂-C₆alkoxy-, C₁-C₆ alkoxy-C₂-C₆alkoxy-C₁-C₃alkyl-, C₃-C₆cycloalkylC₁-C₃-alkyl-, amino, C₁-C₆alkylamino, C₁-C₆dialkylamino, C₁-C₃ alkylcarbonylaminoC₁-C₄alkyl-, C₁-C₆alkyl-S(O)p-, C₁-C₆alkyl-S(O)p-C₁-C₃-alkyl, C₁-C₆haloalkyl-S(O)p- and C₁-C₆haloalkyl-S(O)p-C₁-C₃-alkyl;
R³ is selected from the group consisting of hydrogen, hydroxyl, halo, nitro, amino, cyano, C₁-C₆alkyl, C₁-C₃alkoxy, C₃-C₆cycloalkyl, C₂-C₆alkenyl, C₂-C₆alkynyl, C₁-C₆haloalkyl, C₁-C₆alkoxy-C₁-C₃-alkyl, C₃-C₆cycloalkyl-C₁-C₃-alkyl, C₁-C₆alkyl-S(O)p-, C₁-C₆alkyl-S(O)ₚ—C₁-C₃-alkyl, C₁-C₆haloalkyl-S(O)ₚ—, C₁-C₃alkylamino, C₁-C₃dialkylamino and C₁-C₆haloalkyl-S(O)ₚ—C₁-C₃-alkyl;
R⁴ is selected from the group selected from hydrogen, C₁-C₆alkylcarbonyl, arylcarbonyl, C₁-C₆alkoxycarbonyl, C₁-C₆alkyl-S(O)ₚ—, C₁-C₆alkyl-S(O)ₚcarbonyl- and aryl-S(O)p-, wherein said aryl groups may be optionally substituted by one or more R¹¹;
R⁵ is selected from the group consisting of hydroxyl, halogen, C₁-C₆alkyl, C₁-C₆cycloalkyl, C₁-C₆haloalkyl, C₂-C₆alkenyl, C₂-C₆haloalkenyl, C₂-C₆alkynyl, C₁-C₆ alkoxy, C₂-C₆ alkenyloxy-, C₃-C₆cycloalkylC₁-C₃-alkyl-, C₁-C₆ alkoxyC₁-C₃alkyl, C₁-C₆ alkoxy-C₂-C₆alkoxy, C₁-C₆ alkoxy-C₂-C₆alkoxy-C₁-C₃alkyl, C₁-C₆ haloalkoxy, C₁-C₆ haloalkoxy-C₁-C₃alkyl, C₁-C₆alkyl-S(O)p-, C₁-C₆haloalkyl-S(O)p-, aryl, aryl-S(O)p, heterocyclyl, heterocyclyl-S(O)p, aryloxy, aryl-C₂-C₆alkyl-, aryl-C₁-C₆alkoxy-, heterocyclyloxy, heterocyclyl-C₁-C₃alkoxy-C₁-C₃alkyl, hydroxycarbonyl, hydroxycarbonyl-C₁-C₃ alkoxy-, C₁-C₃ alkoxycarbonyl, C₁-C₃ alkoxycarbonyl-C₁-C₃ alkoxy-, C₁-C₃alkylamino-, C₁-C₃dialkylamino-, C₁-C₃ alkylamino-S(O)p-, C₁-C₃ alkylamino-S(O)p-C₁-C₃alkyl-, C₁-C₃ dialkylamino-S(O)p-, C₁-C₃ dialkylamino-S(O)p-C₁-C₃alkyl-, C₁-C₃alkylaminocarbonyl-, C₁-C₃alkylaminocarbonyl-C₁-C₃alkyl-, C₁-C₃dialkylaminocarbonyl-, C₁-C₃ dialkylaminocarbonyl-C₁-C₃alkyl-, C₁-C₃alkylcarbonylamino-, C₁-C₃ alkyl-S(O)ₚ-amino-, C₁-C₃alkyl-S(O)p-C₁-C₃alkylamino-, C₁-C₃alkyl-S(O)p-aminoC₁-C₃alkyl-, cyano and nitro, wherein said heterocyclyls are five or six membered heterocyclyls containing from one to three heteroatoms each independently selected from the group consisting of oxygen, nitrogen and sulphur, and wherein the aryl or heterocyclyl components may be optionally substituted by one or more substituents selected from the group consisting of halo, C₁-C₃alkyl, C₁-C₃haloalkyl, C₁-C₃ alkoxy, C₁-C₃ haloalkoxy, phenyl, cyano and nitro;
R⁶ and R⁹ are independently selected from the group consisting of hydrogen, hydroxyl, halogen, C₁-C₆alkyl, C₁-C₆cycloalkyl, C₁-C₆haloalkyl, C₂-C₆alkenyl, C₂-C₆haloalkenyl, C₂-C₆alkynyl, C₁-C₆ alkoxy-, C₂-C₆ alkenyloxy-, C₃-C₆cycloalkylC₁-C₃-alkyl-, C₁-C₆ alkoxyC₁-C₃alkyl-, C₁-C₆ alkoxy-C₂-C₆alkoxy-, C₁-C₆ alkoxy-C₂-C₆alkoxy-C₁-C₃alkyl-, C₁-C₆ haloalkoxy-, C₁-C₆ haloalkoxy-C₁-C₃alkyl-, C₁-C₆alkyl-S(O)ₚ—, C₁-C₆haloalkyl-S(O)ₚ—, aryl, aryl-S(O)ₚ—, heterocyclyl, heterocyclyl-S(O)ₚ—, aryloxy-, aryl-C₂-C₆alkyl-, aryl-C₁-C₆alkoxy-, heterocyclyloxy-, heterocyclyl-C₁-C₃alkoxy-C₁-C₃alkyl-, hydroxycarbonyl, hydroxycarbonyl-C₁-C₃alkoxy-, C₁-C₃ alkoxycarbonyl-, C₁-C₃alkoxycarbonyl-C₁-C₃ alkoxy-, C₁-C₃alkylamino-, C₁-C₃dialkylamino-, C₁-C₃alkylamino-S(O)ₚ—, C₁-C₃ alkylamino-S(O)ₚ—C₁-C₃alkyl-, C₁-C₃ dialkylamino-S(O)ₚ—, C₁-C₃ dialkylamino-S(O)ₚ—C₁-C₃alkyl-, C₁-C₃alkylaminocarbonyl-, C₁-C₃alkylaminocarbonyl-C₁-C₃alkyl-, C₁-C₃dialkylaminocarbonyl-, C₁-C₃ dialkylaminocarbonyl-C₁-C₃alkyl-, C₁-C₃alkylcarbonylamino-, C₁-C₃ alkyl-S(O)ₚ-amino-, C₁-C₃alkyl-S(O)ₚ—C₁-C₃alkylamino-, C₁-C₃alkyl-S(O)p-aminoC₁-C₃alkyl-, cyano and nitro, wherein said heterocyclyls are five or six membered heterocyclyls containing from one to three heteroatoms each independently selected from the group consisting of oxygen, nitrogen and sulphur, and wherein the aryl or heterocyclyl components may be optionally substituted by one or more substituents selected from the group consisting of halo, C₁-C₃alkyl, C₁-C₃haloalkyl, C₁-C₃ alkoxy, C₁-C₃ haloalkoxy, C₁-C₆alkyl-S(O)ₚ—, phenyl, cyano and nitro;
R⁷ is selected from the group consisting of hydrogen, halogen, C₁-C₃ alkyl-, C₁-C₃ alkoxy-, C₂-C₃alkenyl-, C₂-C₃alkynyl-, C₁-C₃ haloalkyl- and C₁-C₃haloalkoxy-;
R⁸ is hydrogen; or
R⁵ and R⁹ can together form a saturated or unsaturated 5- or 6-membered carbocyclic or heterocyclic ring, said heterocyclic ring comprising one or more nitrogen and/or oxygen heteroatoms, the 5- or 6-membered ring being optionally substituted by one or more R¹²; or
R⁶ and R⁹ can together form a saturated or unsaturated 5- or 6-membered carbocyclic or heterocyclic ring, said heterocyclic ring comprising one or more heteroatoms selected from the group consisting of nitrogen, oxygen and S(O)₂, the 5- or 6-membered ring being optionally substituted by one or more R¹²; or
R⁶ and R⁸ can together form an unsaturated 5- or 6-membered carbocyclic or heterocyclic ring, said heterocyclic ring comprising one or more nitrogen heteroatoms, the 5- or 6-membered ring being optionally substituted by one or more R¹³; and
R¹¹ is selected from the group consisting of halo-, C₁-C₃alkyl, C₁-C₃ haloalkyl and C₁-C₆alkoxy;
R¹² is selected from the group of hydrogen, cyano, halo-, oxy-, C₁-C₃alkylS(O)p-, C₁-C₃ alkyl, C₂-C₃alkenyl, C₂-C₃alkynyl, C₁-C₃ alkoxy and C₁-C₃ haloalkyl;
R¹³ is selected from the group of hydrogen, cyano, halo-, C₁-C₃alkylS(O)p-, C₁-C₃ alkyl, C₂-C₃alkenyl, C₂-C₃alkynyl, morpholinyl- and C₁-C₃ haloalkyl; and
p=0, 1 or 2.

2. A compound according to claim 1, wherein R³ and/or R⁴ is hydrogen.

3. A compound according to claim 1, wherein R¹ is selected from the group consisting of A1a, A1b, A1c, A1d, A2a, A2b and A2c: 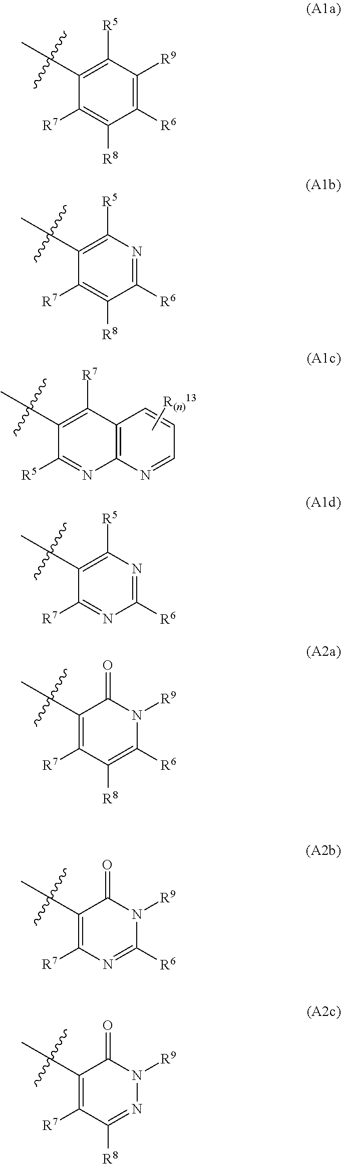
wherein R⁵, R⁶, R⁷, R⁸, R⁹ and R¹³ are as defined in claim 1 and n is 0, 1, 2 or 3.

4. A compound according to claim 3, wherein R¹ is A1a or A1b.

5. A compound according to claim 1, wherein R² is selected from the group consisting of hydrogen, amino, chloro, bromo, methyl, ethyl, isopropyl, vinyl, isopropenyl, methyl-S(O)ₚ—, cyclopropyl and cyano.

6. A compound according to claim 1, wherein R⁵ is selected from the group consisting of hydroxyl, halogen, C₁-C₆alkyl, C₁-C₆cycloalkyl, C₁-C₆haloalkyl, C₁-C₆ alkoxy, C₁-C₆ alkoxyC₁-C₃alkyl, C₁-C₆ alkoxy-C₂-C₆alkoxy-C₁-C₃alkyl, C₁-C₆ haloalkoxyC₁-C₃alkyl, C₁-C₆alkyl-S(O)ₚ—, aryl, aryloxy, heterocyclyl-C₁-C₃alkoxy-C₁-C₃alkyl, C₁-C₃dialkylamino-, C₁-C₃alkyl-S(O)ₚ-amino-C₁-C₃dialkyl, cyano and nitro.

7. A compound according to claim 6, wherein R⁵ is selected from the group consisting of chloro, methyl, trifluoromethyl, and methylS(O)ₚ—.

8. A compound according to claim 1, wherein R⁶ is selected from the group consisting of hydrogen, halogen, C₁-C₆alkyl, C₁-C₆haloalkyl, C₁-C₆alkyl-S(O)ₚ—, C₂-C₆alkenyl and C₂-C₆alkynyl.

9. A compound according to claim 1, wherein R⁷ is selected from the group consisting of hydrogen, halogen and C₁-C₃ alkyl-.

10. A compound according to claim 1, wherein R⁹ is selected from the group consisting of hydrogen, 4,5-dihydroisoxazol-3-yl halogen, C₁-C₆alkyl, C₁-C₆haloalkyl, C₁-C₆alkyl-S(O)ₚ—, C₂-C₆alkenyl and C₂-C₆alkynyl.

11. A herbicidal composition comprising a herbicidal compound according to claim 1 and an agriculturally acceptable formulation adjuvant.

12. A herbicidal composition according to claim 11, further comprising at least one additional pesticide.

13. A herbicidal composition according to claim 12, wherein the additional pesticide is a herbicide or herbicide safener.

14. A method of controlling weeds at a locus comprising application to the locus of a weed controlling amount of a composition according to claim 11.

15. (canceled)
